(19) United States
(12) Patent Application Publication
(10) Pub. No.: US 2023/0323029 A1
(43) Pub. Date: Oct. 12, 2023

(54) POLYMERS BASED ON IONIC MONOMERS, COMPOSITIONS COMPRISING SAME, METHODS FOR MANUFACTURING SAME, AND USE THEREOF IN ELECTROCHEMICAL APPLICATIONS

(71) Applicant: HYDRO-QUÉBEC, Montréal (CA)

(72) Inventors: Jean-Christophe DAIGLE, St-Bruno-de-Montarville (CA); Annie-Pier LAROUCHE, Sainte-Julie (CA); Patrick CHAREST, Sainte-Julie (CA); Abdelbast GUERFI, Brossard (CA); Martin DONTIGNY, Varennes (CA); Michel ARMAND, Paris (FR); Karim ZAGHIB, Longueuil (CA); Andreas HINTENNACH, Tamm (DE)

(73) Assignee: HYDRO-QUÉBEC, Montréal, QC (CA)

(21) Appl. No.: 17/758,365

(22) PCT Filed: Jan. 22, 2021
(86) PCT No.: PCT/CA2021/050071

§ 371 Date: Jul. 5, 2022

Related U.S. Application Data
(60) Provisional application No. 62/965,560, filed on Jan. 24, 2020.
(60) Provisional application No. 62/977,521, filed on Feb. 17, 2020.

(30) Foreign Application Priority Data
Nov. 5, 2020 (EP) 20206000.0

(51) Int. Cl. C08G 65/34; H01M 4/62; H01M 4/36; H01M 4/583; H01M 4/58; H01M 4/04; H01M 10/0525

(52) U.S. Cl. CPC C08G 65/34; H01M 4/622; H01M 4/625; H01M 4/366; H01M 4/583; H01M 4/5825; H01M 4/0404; H01M 10/0525; H01M 2004/027

(57) ABSTRACT

The present technology relates to an ionic polymer comprising at least one repeating unit comprising the reaction product between at least one compound comprising at least two functional groups and a metal bis(halosulfonyl)imide for use in electrochemical applications, particularly in electrochemical accumulators such as batteries, electrochromic devices and supercapacitors. The present technology also relates to a polymer composition, a solid polymer electrolyte composition, a solid polymer electrolyte, an electrode material comprising said ionic polymer. Their uses in electrochemical cells and electrochemical accumulators as well as their manufacturing processes are also described.

### RELATED APPLICATIONS

This application claims priority under applicable law to United States Provisional Patent Application No. 62/965,560 filed on Jan. 24, 2020, U.S. Provisional Patent Application No. 62/977,521 filed on Feb. 17, 2020, and European Patent Application No. 20 206 000.0 filed on Nov. 5, 2020, the contents of which are incorporated herein by reference in their entirety and for all purposes.

### TECHNICAL FIELD

The present application relates to the field of polymers and their use in electrochemical applications. More particularly, the present application relates to the field of solid polymer electrolytes, polymer compositions, solid polymer electrolyte compositions, their manufacturing processes and their uses in electrochemical cells, electrochromic devices, supercapacitors, or electrochemical accumulators, particularly in all-solid-state batteries.

### BACKGROUND

Solid polymer electrolytes are promising materials for many technological applications as they allow the development of all-solid-state electrochemical systems that are substantially safer, lighter, more flexible and efficient than their counterparts based on the use of liquid electrolytes.

Despite their significant advantages, the use of solid polymer electrolytes is still limited mainly due to their limited electrochemical stability, low transport number and relatively low ionic conductivity. Indeed, the electrochemical stability window of conventional solid-state polymer electrolytes is still relatively limited, as conventional solid-state polymer electrolytes generally do not support high-voltage operation (≥4 V vs. Li/Li⁺).

In addition, conventional solid polymer electrolytes such as those based on poly(ethylene oxide) (PEO) face ionic conductivity problems at ambient temperature. For example, the ionic conductivity of PEO is of the order of 10-3 S·cm⁻¹ when the polymer is in the molten state (Hallinan et al., Annual review of materials research 43 (2013): 503-525). However, ion transport occurs mainly in the amorphous phase and decreases in the crystalline phase resulting in a significant decrease in the ionic conductivity of PEO-based polymers. Indeed, the ionic conductivity of a PEO-based polymer substantially decreases at operating temperatures below its melting point (Armand, M. Solid State Ionics 9 (1983): 745-754). The degree of crosslinking of POE-based polymers is also associated with electrochemical stability and low ionic conductivity issues, particularly due to reduced segmental mobility.

A common approach to solving the low ionic conductivity issue involves the modification of the polymer structure to decrease its crystallinity, for example, by using branched or block PEO-based polymers comprising monomeric units decreasing the crystallization temperature, the glass transition temperature, or by increasing the ionic transport number. Another strategy employed to address this problem involves the incorporation of nanoscale ceramic fillers such as titanium dioxide (TiO₂), alumina (Al₂O₃), silicon dioxide (SiO₂) and lithium aluminate (LiAlO₂) nanoparticles in PEO-based polymers in order to improve their mechanical strength. However, the presence of these fillers can contribute to a decrease in electrochemical and/or mechanical properties of the polymer.

Consequently, there is a need for the development of solid polymer electrolytes excluding one or more of the drawbacks of conventional solid polymer electrolytes.

### SUMMARY

According to one aspect, the present technology relates to an ionic polymer comprising at least one repeating unit comprising the reaction product between at least one compound of Formula 1 comprising at least two functional groups and a metal bis(halosulfonyl)imide of Formula 2:

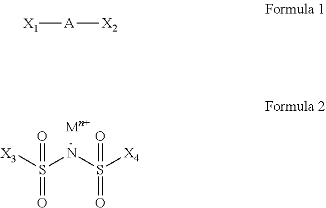

wherein,
A is a substituted or unsubstituted organic group selected from a linear or branched C₁-C₁₀alkylene, a linear or branched C₁-C₁₀alkyleneoxyC₁-C₁₀alkylene, a linear or branched poly(C₁-C₁₀alkyleneoxy)C₁-C₁₀alkylene, a linear or branched polyether and a linear or branched polyester;
X₁ and X₂ are functional groups independently and at each occurrence selected from a hydroxyl group, a thiol group and an amine group;
X₃ and X₄ are halogen atoms each independently selected from F, Cl, Br and I; and
Mⁿ⁺ is an alkali or alkaline earth metal ion selected from the group consisting of Na⁺, K⁺, Li⁺, Ca²⁺ and Mg²⁺ ions.

In one embodiment, the compound of Formula 1 is selected from glycerol, alkane diols, 1,3-propanediol, 1,4-butanediol, 1,5-pentanediol, 1,6-hexanediol, 1,8-octanediol, 1,2-propanediol, 1,2-butanediol, 2,3-butanediol, 1,3-butanediol, 1,2-pentanediol, etohexadiol, p-menthane-3,8-diol, 2-methyl-2,4-pentanediol, polycaprolactone diol, ethylene glycol, diethylene glycol, triethylene glycol, tetraethylene glycol, pentaethylene glycol, polyethylene glycol, 2,2,3,3,4,4,5,5-octafluoro-1,6-hexanediol, other similar glycols and diols, and a combination of at least two thereof.

In another embodiment, the compound of Formula 1 is selected from alkane diamines, 1,3-propanediamine, 1,4-butanediamine, 1,5-pentanediamine, 1,6-hexanediamine, 1,8-octanediamine, 1,2-propanediamine, 1,2-butanediamine, 2,3-butanediamine, 1,3-butanediamine, 1,2-pentanediamine, 2,4-diamino-2-methylpentane, ethylenediamine, 1,8-diamino-3,6-dioxaoctane, 1,11-diamino-3,6,9-trioxaundecane, 4,9-dioxa-1,12-dodecanediamine, 1,14-diamino-3,6,9,12-tetraoxatetradecane, poly(ethylene glycol) diamine, D, ED or EDR series products commercialized under the brand JEFFAMINE®, other similar diamines, and a combination of at least two thereof.

In another embodiment, A is an optionally substituted linear or branched C₁-C₁₀alkylene and the compound of Formula 1 is a compound of Formula 3:

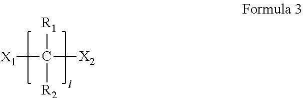

wherein,
X₁ and X₂ are as herein defined;
R₁ and R₂ are independently and at each occurrence selected from a hydrogen atom, a hydroxyl group, a thiol group, an amine group, a halogen atom selected from F, Cl, Br and I, and linear or branched substituents selected from C₁-C₁₀alkyl, C₁-C₁₀alkyl-acrylate, C₁-C₁₀alkyl-methacrylate, oxycarbonyl-C₁-C₁₀alkyl-methacrylate, oxycarbonyl-C₁-C₁₀alkyl-acrylate, aminocarbonyl-C₁-C₁₀alkyl-methacrylate, aminocarbonyl-C₁-C₁₀alkyl-acrylate, oxycarbonylamino-C₁-C₁₀alkyl-methacrylate, and oxycarbonylamino-C₁-C₁₀alkyl-acrylate; and
l is a number in the range of 1 to 10.

In another embodiment, A is a linear or branched and optionally substituted poly(C₁-C₁₀alkyleneoxy)C₁-C₁₀alkylene and the compound of Formula 1 is a compound of Formula 4:

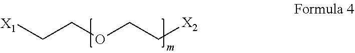

wherein,
X₁ and X₂ are as herein defined; and
m is a number between 1 and 68.

In another embodiment, A is a linear or branched and optionally substituted polyether and the compound of Formula 1 is a compound of Formula 5:

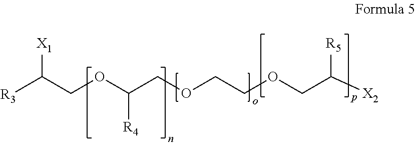

wherein,
X₁ and X₂ are as herein defined;
R₃, R₄ and R₅ are independently and at each occurrence selected from C₁-C₁₀alkyl groups;
n, o and p are selected such that the number average molecular weight of the polyether is between about 220 g/mol and about 2,000 g/mol, upper and lower limits included;
n and p are selected such that the sum (n+p) is between about 1 and about 6; and
o is a number between about 2 and about 39.

In another embodiment, R₃, R₄ and R₅ are methyl groups.

In another embodiment, X₁ and X₂ are both amine groups.

In another embodiment, A is an optionally substituted aliphatic polyester, such as polycaprolactone, and the compound of Formula 1 is a compound of Formula 7:

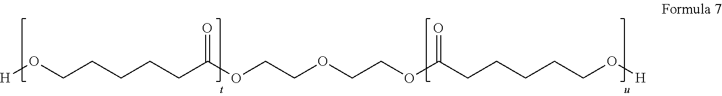

wherein,
t and u are numbers in the range of 1 to 10.

According to another aspect, the present technology relates to an ionic polymer comprising at least one repeating unit of Formula 8 (a) or is a polymer of Formula 8 (b):

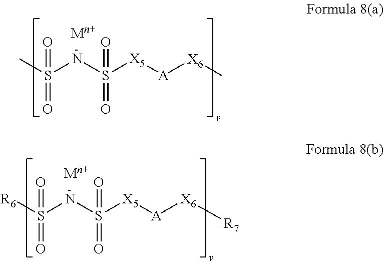

wherein,
A is a substituted or unsubstituted organic group independently and at each occurrence selected from a linear or branched C₁-C₁₀alkylene, a linear or branched C₁-C₁₀alkyleneoxyC₁-C₁₀alkylene, a linear or branched poly(C₁-C₁₀alkyleneoxy)C₁-C₁₀alkylene, a linear or branched polyether and a linear or branched polyester;
X₅ and X₆ are each independently selected from an oxygen atom, a sulfur atom and an —NH group;
R₆ is selected from a hydroxyl group, a thiol group, an amine group and a R₇—X₅-A-X₆— group;
R₇ is a crosslinkable group independently at each occurrence selected from acrylate, methacrylate, C₁-C₁₀alkyl-acrylate, C₁-C₁₀alkyl-methacrylate, carbonyl-C₁-C₁₀alkyl-methacrylate carbonyl-C₁-C₁₀alkyl-acrylate, carbonyloxy-C₁-C₁₀alkyl-methacrylate, carbonyloxy-C₁-C₁₀alkyl-acrylate, carbonylamino-C₁-C₁₀alkyl-methacrylate and carbonylamino-C₁-C₁₀alkyl-acrylate;
Mⁿ⁺ is an alkali or alkaline earth metal ion selected from the group consisting of Na⁺, K⁺, Li⁺, Ca²⁺ and Mg²⁺ ions; and
v is a number selected such that the number average molecular weight of the ionic polymer is between about 8,000 g/mol and about 150,000 g/mol, upper and lower limits included.

According to another aspect, the present technology relates to an ionic polymer comprising at least one repeating unit of Formula 9:

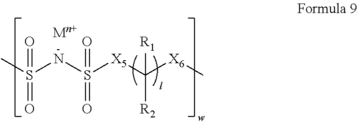

wherein,
Mⁿ⁺ is an alkali or alkaline earth metal ion selected from the group consisting of Na⁺, K⁺, Li⁺, Ca²⁺ and Mg²⁺ ions;
X₅ and X₆ are each independently selected from an oxygen atom, a sulfur atom and an —NH group;
R₁ and R₂ are independently and at each occurrence selected from a hydrogen atom, a hydroxyl group, a thiol group, an amine group, a halogen atom selected from F, Cl, Br and I, and linear or branched substituents selected from C₁-C₁₀alkyl, C₁-C₁₀alkyl-acrylate, C₁-C₁₀alkyl-methacrylate, oxycarbonyl-C₁-C₁₀alkyl-methacrylate, oxycarbonyl-C₁-C₁₀alkyl-acrylate, aminocarbonyl-C₁-C₁₀alkyl-methacrylate, aminocarbonyl-C₁-C₁₀alkyl-acrylate, oxycarbonylamino-C₁-C₁₀alkyl-methacrylate, and oxycarbonylamino-C₁-C₁₀alkyl-acrylate;
l is a number in the range of 1 to 10; and
w is a number selected such that the number average molecular weight of the ionic polymer is between about 8,000 g/mol and about 150,000 g/mol, upper and lower limits included.

According to another aspect, the present technology relates to an ionic polymer comprising at least one repeating unit of Formula 10:

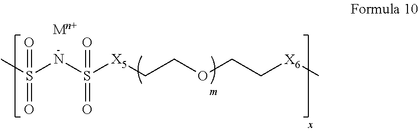

wherein,
Mⁿ⁺ is an alkali or alkaline earth metal ion selected from the group consisting of Na⁺, K⁺, Li⁺, Ca²⁺ and Mg²⁺ ions;
X₅ and X₆ are each independently selected from an oxygen atom, a sulfur atom and an —NH group;
m is a number in the range of 1 to 68; and
x is a number selected such that the number average molecular weight of the ionic polymer is between about 8,000 g/mol and about 150,000 g/mol, upper and lower limits included.

According to another aspect, the present technology relates to an ionic polymer comprising at least one repeating unit of Formula 11:

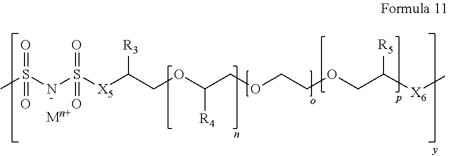

wherein,
Mⁿ⁺ is an alkali or alkaline earth metal ion selected from the group consisting of Na⁺, K⁺, Li⁺, Ca²⁺ and Mg²⁺ ions;
X₅ and X₆ are each independently selected from an oxygen atom, a sulfur atom and an —NH group;
R₃, R₄ and R₅ are independently and at each occurrence selected from C₁-C₁₀alkyl groups;
n and p are selected such that the sum (n+p) is between about 1 and about 6;
o is a number between about 2 and about 39; and
y is a number selected such that the number average molecular weight of the ionic polymer is between about 8,000 g/mol and about 150,000 g/mol, upper and lower limits included.

According to another aspect, the present technology relates to an ionic polymer comprising at least one repeating unit of Formula 12:

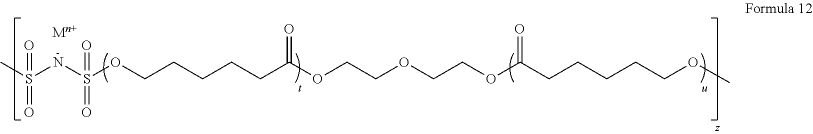

wherein,
Mⁿ⁺ is an alkali or alkaline earth metal ion selected from the group consisting of Na⁺, K⁺, Li⁺, Ca²⁺ and Mg²⁺ ions;
t and u are numbers between 1 and 10; and
z is a number selected such that the number average molecular weight of the ionic polymer is between about 8,000 g/mol and about 150,000 g/mol, upper and lower limits included.

According to another aspect, the present technology relates to an ionic polymer comprising at least one fragment of Formula 13:

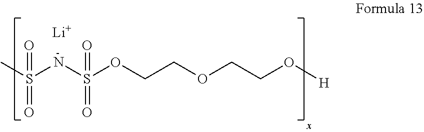

wherein,
x is a number selected such that the number average molecular weight of the ionic polymer is between about 8,000 g/mol and about 150,000 g/mol, upper and lower limits included.

According to another aspect, the present technology relates to an ionic polymer comprising at least one fragment of Formula 14:

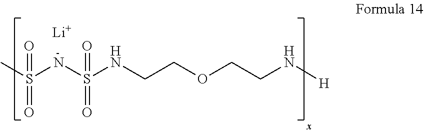

wherein,
x is a number selected such that the number average molecular weight of the ionic polymer is between about 8,000 g/mol and about 150,000 g/mol, upper and lower limits included.

According to another aspect, the present technology relates to an ionic polymer comprising at least one fragment of Formula 15:

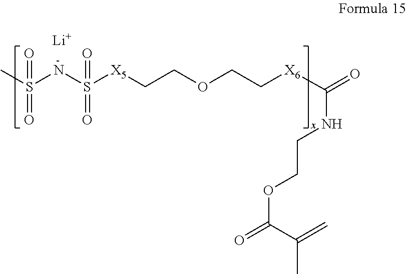

wherein,
X₅ and X₆ are each independently selected from an oxygen atom, a sulfur atom and an —NH group; and
x is a number selected such that the number average molecular weight of the ionic polymer is between about 8,000 g/mol and about 150,000 g/mol, upper and lower limits included.

According to another aspect, the present technology relates to an ionic polymer comprising at least one fragment of Formula 16:

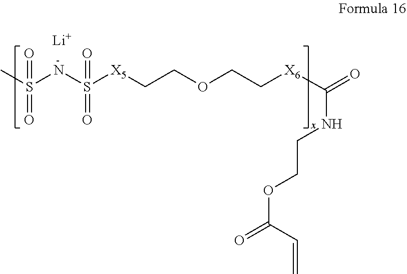

wherein,
X₅ and X₆ are each independently selected from an oxygen atom, a sulfur atom and an —NH group; and
x is a number selected such that the number average molecular weight of the ionic polymer is between about 8,000 g/mol and about 150,000 g/mol, upper and lower limits included.

According to another aspect, the present technology relates to an ionic polymer comprising at least one fragment of Formula 17:

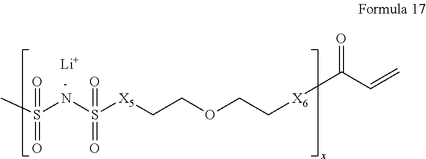

wherein,
X₅ and X₆ are each independently selected from an oxygen atom, a sulfur atom and an —NH group; and
x is a number selected such that the number average molecular weight of the ionic polymer is between about 8,000 g/mol and about 150,000 g/mol, upper and lower limits included.

According to another aspect, the present technology relates to an ionic polymer comprising at least one fragment of Formula 18:

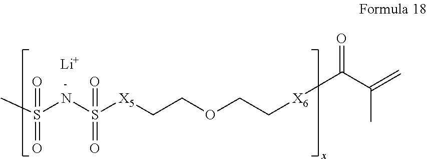

wherein,
X₅ and X₆ are each independently selected from an oxygen atom, a sulfur atom and an —NH group; and
x is a number selected such that the number average molecular weight of the ionic polymer is between about 8,000 g/mol and about 150,000 g/mol, upper and lower limits included.

According to another aspect, the present technology relates to an ionic polymer comprising at least one fragment of Formula 19:

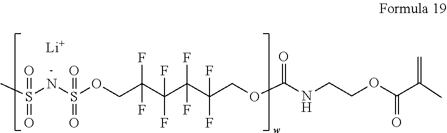

wherein,
w is a number selected such that the number average molecular weight of the ionic polymer is between about 8,000 g/mol and about 150,000 g/mol, upper and lower limits included.

According to another aspect, the present technology relates to an ionic polymer comprising at least one fragment of Formula 20:

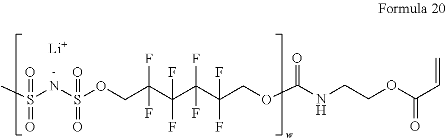

wherein,
w is a number selected such that the number average molecular weight of the ionic polymer is between about 8,000 g/mol and about 150,000 g/mol, upper and lower limits included.

According to another aspect, the present technology relates to an ionic polymer comprising at least one fragment of Formula 21:

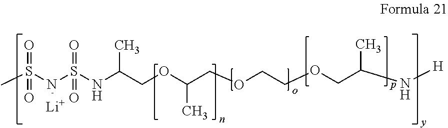

wherein,
n and p are selected such that the sum (n+p) is between about 1 and about 6;
o is a number between about 2 and about 39; and
y is a number selected such that the number average molecular weight of the ionic polymer is between about 8,000 g/mol and about 150,000 g/mol, upper and lower limits included.

According to another aspect, the present technology relates to an ionic polymer comprising at least one fragment of Formula 22:

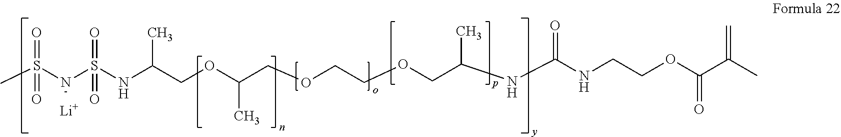

wherein,
n and p are selected such that the sum (n+p) is between about 1 and about 6;
o is a number between about 2 and about 39; and
y is a number selected such that the number average molecular weight of the ionic polymer is between about 8,000 g/mol and about 150,000 g/mol, upper and lower limits included.

According to another aspect, the present technology relates to an ionic polymer comprising at least one fragment of Formula 23:

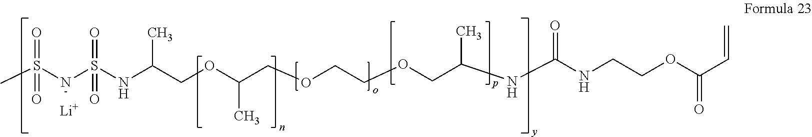

wherein,
n and p are selected such that the sum (n+p) is between about 1 and about 6;
o is a number between about 2 and about 39; and
y is a number selected such that the number average molecular weight of the ionic polymer is between about 8,000 g/mol and about 150,000 g/mol, upper and lower limits included.

According to another aspect, the present technology relates to an ionic polymer comprising at least one fragment of Formula 24:

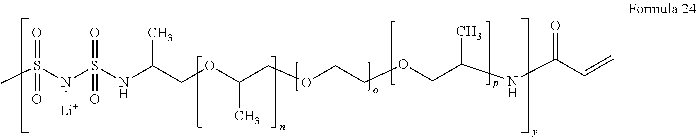

wherein,
n and p are selected such that the sum (n+p) is between about 1 and about 6;
o is a number between about 2 and about 39; and
y is a number selected such that the number average molecular weight of the ionic polymer is between about 8,000 g/mol and about 150,000 g/mol, upper and lower limits included.

According to another aspect, the present technology relates to an ionic polymer comprising at least one fragment of Formula 25:

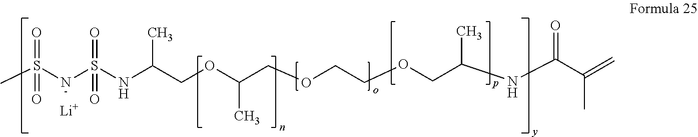

wherein,
n and p are selected such that the sum (n+p) is between about 1 and about 6;
o is a number between about 2 and about 39; and
y is a number selected such that the number average molecular weight of the ionic polymer is between about 8,000 g/mol and about 150,000 g/mol, upper and lower limits included.

According to another aspect, the present technology relates to an ionic polymer comprising at least one fragment of Formula 26:

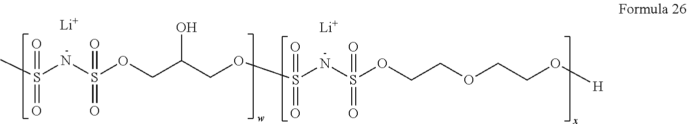

wherein,
w and x are numbers selected such that the number average molecular weight of the ionic polymer is between about 8,000 g/mol and about 150,000 g/mol, upper and lower limits included.

According to another aspect, the present technology relates to an ionic polymer comprising at least one fragment of Formula 27:

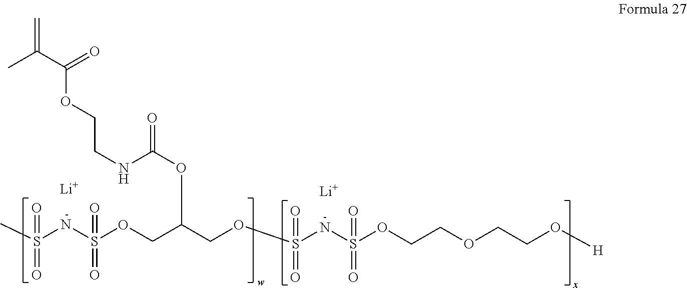

wherein,
w and x are numbers selected such that the number average molecular weight of the ionic polymer is between about 8,000 g/mol and about 150,000 g/mol, upper and lower limits included.

According to another aspect, the present technology relates to an ionic polymer comprising at least one fragment of Formula 28:

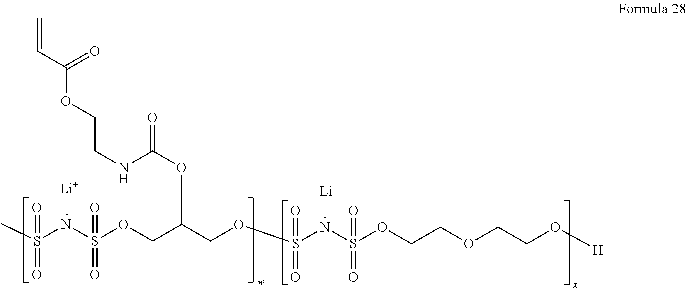

wherein,
w and x are numbers selected such that the number average molecular weight of the ionic polymer is between about 8,000 g/mol and about 150,000 g/mol, upper and lower limits included.

According to another aspect, the present technology relates to a polymer composition comprising at least one ionic polymer as defined herein.

In one embodiment, the polymer composition further comprises at least one additional component or additive. According to one example, the additional component or additive is selected from ionic conductors, inorganic particles, glass particles, ceramic particles, salts, and other similar additives, or a combination of at least two thereof. According to another example, the additional component or additive is a filler additive selected from titanium dioxide (TiO₂), alumina (Al₂O₃) and silicon dioxide (SiO₂) particles or nanoparticles.

In another embodiment, the polymer composition is used in an electrochemical cell. In another embodiment, the polymer composition is a solid polymer electrolyte composition. In another embodiment, the polymer composition is a binder for electrode material. In another embodiment, the polymer composition is used in a supercapacitor. According to one example, the supercapacitor is a carbon-carbon supercapacitor. In another embodiment, the polymer composition is used in an electrochromic material.

According to another aspect, the present technology relates to a solid polymer electrolyte composition comprising a polymer composition as herein defined.

In another embodiment, the solid polymer electrolyte composition further comprises at least one salt. According to one example, the salt is an ionic salt selected from a lithium salt, a sodium salt, a potassium salt, a calcium salt, and a magnesium salt.

In another embodiment, the solid polymer electrolyte composition further comprises at least one additional component or additive. According to one example, the additional component or additive is selected from ionic conductive materials, inorganic particles, glass particles, ceramic particles, a combination of at least two thereof, and other similar additives.

According to another aspect, the present technology relates to a solid polymer electrolyte comprising a solid polymer electrolyte composition as herein defined.

According to another aspect, the present technology relates to an electrode material comprising an electrochemically active material and a polymer composition as herein defined. In one embodiment, the polymer composition is a binder.

In another embodiment, the electrochemically active material is in the form of particles. According to one example, the electrochemically active material is selected from a metal oxide, a lithium metal oxide, a metal phosphate, a lithiated metal phosphate, a titanate and a lithium titanate. According to another example, the metal of the electrochemically active material is selected from titanium (Ti), iron (Fe), magnesium (Mg), manganese (Mn), vanadium (V), nickel (Ni), cobalt (Co), aluminum (Al), chromium (Cr), copper (Cu), antimony (Sb), and a combination of at least two thereof.

In another embodiment, the electrode material further comprises at least one electronically conductive material. According to one example, the electronically conductive material is selected from carbon black, acetylene black, graphite, graphene, carbon fibers, carbon nanofibers, carbon nanotubes, and a combination of at least two thereof.

In another embodiment, the electrode material further comprises at least one additional component or additive. According to one example, the additional component or additive is selected from ionic conductors, inorganic particles, glass or ceramic particles, nanoceramics, salts, and other similar additives. According to another example, the additional component or additive is selected from Al₂O₃, TiO₂ and SiO₂.

In another embodiment, the electrode material is a positive electrode material. In another embodiment, the electrode material is a negative electrode material. According to one example, the electrochemically active material is a lithium titanate or a carbon-coated lithium titanate.

According to another aspect, the present technology relates to an electrode comprising an electrode material as defined herein on a current collector.

According to another aspect, the present technology relates to an electrochemical cell comprising a negative electrode, a positive electrode and an electrolyte, wherein at least one of the negative electrode, the positive electrode and the electrolyte comprises a polymer composition as herein defined.

According to another aspect, the present technology relates to an electrochemical cell comprising a negative electrode, a positive electrode and an electrolyte, wherein at least one of the negative electrode and the positive electrode is as herein defined.

According to another aspect, the present technology relates to an electrochemical cell comprising a negative electrode, a positive electrode and a solid polymer electrolyte as herein defined.

According to another aspect, the present technology relates to an electrochemical accumulator comprising at least one electrochemical cell as herein defined.

In one embodiment, the electrochemical accumulator is a battery selected from a lithium battery, a lithium-ion battery, a sodium battery, a sodium-ion battery, a magnesium battery, and a magnesium-ion battery. According to one example, said battery is a lithium battery or a lithium-ion battery.

According to another aspect, the present technology relates to a process for preparing a polymer or polymer composition as herein defined, the process comprising the following steps of:
(i) preparing a metal bis(halosulfonyl)imide of Formula 2; and
(ii) reacting at least one compound of Formula 1 including at least two functional groups as herein defined with said metal bis(halosulfonyl)imide of Formula 2.

In another embodiment, the process further comprises a step of preparing a bis(halosulfonyl)imide. According to one example, the step of preparing a bis(halosulfonyl)imide is carried out by the reaction between sulfamic acid and a halosulfonic acid in the presence of at least one halogenating agent.

According to one example, the halogenating agent is selected from phosphorus trichloride, phosphorus pentachloride, thionyl chloride, thionyl fluoride, phosphorus oxychloride and oxalyl chloride. According to one example, the halogenating agent is thionyl chloride. According to another example, the halosulfonic acid is chlorosulfonic acid.

In another embodiment, the step of preparing a bis(halosulfonyl)imide is carried out at a temperature in the range of from about 60° C. to about 150° C., or from about 70° C. to about 145° C., or from about 80° C. to about 140° C., or from about 90° C. to about 100° C., or from about 110° C. to about 140° C., or from about 120° C. to about 140° C., or from about 125° C. to about 140° C., or from about 125° C. to about 135° C., upper and lower limits included.

In another embodiment, the bis(halosulfonyl)imide is a bis(chlorosulfonyl)imide.

In another embodiment, the step of preparing a metal bis(halosulfonyl)imide is carried out by a metalation reaction between a bis(halosulfonyl)imide and at least one metalating agent, optionally in the presence of a solvent.

According to one example, the metalating agent comprises an alkali or alkaline earth metal selected from lithium, sodium, potassium, calcium, and magnesium. According to an example, the metalating agent is a lithiating agent selected from lithium hydroxide, lithium carbonate, lithium hydrogen carbonate, lithium hydride, lithium chloride, lithium bromide, lithium iodide, a lithium carboxylate of formula RCO₂Li (wherein R is a linear or branched C₁-C₁₀alkyl group or an aromatic hydrocarbon), lithium oxalate and metallic lithium. According to another example, the lithiating agent is lithium chloride.

In another embodiment, the solvent is selected from N,N-dimethylformamide, N-methyl-2-pyrrolidone, dimethylacetamide, tetrachloromethane, chloroform, acetonitrile, tetrahydrofuran, and a miscible combination of at least two thereof. According to one example, the solvent is N,N-dimethylformamide.

In another embodiment, the step of preparing a metal bis(halosulfonyl)imide of Formula 2 is carried out at a temperature in the range of from about 20° C. to about 150° C., or from about 30° C. to about 135° C., or from about 40° C. to about 130° C., or from about 50° C. to about 125° C., or from about 60° C. to about 120° C., or from about 70° C. to about 115° C., or from about 80° C. to about 110° C., or from about 90° C. to about 105° C., upper and lower limits included.

In another embodiment, the step of preparing the metal bis(halosulfonyl)imide is performed for a period of time in the range of from about 10 hours to about 48 hours, or from about 10 hours to about 24 hours, or from about 12 hours to about 24 hours, upper and lower limits included.

In another embodiment, the step of reacting at least one compound of Formula 1 including at least two functional groups with said metal bis(halosulfonyl)imide of Formula 2 is a polymerization step. According to one example, the polymerization is performed by polycondensation. For example, the polymerization is carried out by polyesterification. According to one example, the polyesterification is carried out by a Fischer esterification reaction or by a Steglich esterification reaction.

In another embodiment, the step of reacting at least one compound of Formula 1 including at least two functional groups with said metal bis(halosulfonyl)imide of Formula 2 is carried out in the presence of a solvent. According to one example, the solvent is selected from N, N-dimethylformamide, N-methyl-2-pyrrolidone, dimethylacetamide, tetrachloromethane, chloroform, acetonitrile, tetrahydrofuran, and a miscible combination of at least two thereof. For example, the solvent is N,N-dimethylformamide.

In another embodiment, the polymerization step is carried out in the presence of at least one base and optionally at least one polymerization catalyst and/or at least one co-catalyst and/or optionally at least one acylation catalyst.

In another embodiment, the polymerization catalyst is selected from the group consisting of an acidic catalyst, a nucleophilic catalyst, and a boron-based catalyst.

In another embodiment, the nucleophilic catalyst is selected from the group consisting of 4-dimethylaminopyridine, pyridine, and other pyridine derivatives.

In another embodiment, the boron-based catalyst is a boric acid-based catalyst, a boronic acid-based catalyst, or a borinic acid-based catalyst. For example, the polymerization catalyst is selected from diarylborinic acids of formula Ar₂BOH (wherein Ar is an aryl group), diphenylborinic acid, phenylboronic acid, trifluorophenyl boronic acid, 9H-9-bora-10-thiaanthracen-9-ol, 10H-phenoxaborin-10-ol, boron tribromide, boron trichloride, acyl fluoborates, triethyloxonium fluoroborate, boron trifluoride etherate, boron trifluoride, tris(pentafluorophenyl)borane, and other similar boron-derived catalysts, or a combination of at least two thereof when compatible.

In another embodiment, the base is selected from triethylamine, N, N-diisopropylethylamine, pyridine and pyridine derivatives. According to one example, the base is triethylamine.

In another embodiment, the process further comprises a post-functionalization or post-polymerization modification step. According to one example, the post-functionalization or post-polymerization modification step is carried out to introduce at least one crosslinkable functional group. According to one example, the post-functionalization or post-polymerization modification step is carried out by reacting at least one functional group with at least one precursor of a crosslinkable functional group. For example, the crosslinkable functional group is selected from acrylate, methacrylate, C₁-C₁₀alkyl-acrylate, C₁-C₁₀alkyl-methacrylate, oxycarbonyl-C₁-C₁₀alkyl-methacrylate, oxycarbonyl-C₁-C₁₀alkyl-acrylate, aminocarbonyl-C₁-C₁₀alkyl-methacrylate aminocarbonyl-C₁-C₁₀alkyl-acrylate, oxycarbonylamino-C₁-C₁₀alkyl-methacrylate, oxycarbonylamino-C₁-C₁₀alkyl-acrylate, carbonyloxy-C₁-C₁₀alkyl-methacrylate, carbonyloxy-C₁-C₁₀alkyl-acrylate, carbonylamino-C₁-C₁₀alkyl-methacrylate and carbonylamino-C₁-C₁₀alkyl-acrylate.

In another embodiment, the process further comprises a separation or purification step. According to one example, the separation or purification step is carried out by a liquid chromatography method or a filtration method.

In another embodiment, the process further comprises a step of coating the polymer composition. According to one example, the coating step is carried out by at least one method selected from a doctor blade coating method, a comma coating method, a reverse-comma coating method, a printing method, a gravure coating method, and a slot-die coating method.

In another embodiment, the process further comprises a step of drying the polymer composition to remove any residual solvent and/or water. According to one example, the step of drying the polymer composition and the step of coating the polymer composition are performed simultaneously.

In another embodiment, the process further comprises a crosslinking step. For example, the crosslinking step is carried out by UV irradiation, heat treatment, microwave irradiation, under an electron beam, by gamma irradiation, or by X-ray irradiation. The crosslinking step may be carried out in the presence of at least one of a crosslinking agent, a thermal initiator, a photoinitiator (for example, a UV initiator), a catalyst, a plasticizing agent, or a combination of at least two thereof.

### BRIEF DESCRIPTION OF THE FIGURES

FIG. 1 is a chromatogram obtained by steric exclusion chromatography (SEC) for Polymer 2, as described in Example 3(b).

FIG. 2 is a proton nuclear magnetic resonance (¹H NMR) spectrum obtained for Polymer 2, as described in Example 3(b).

FIG. 3 is a graph showing the results of differential scanning calorimetry (DSC) analysis obtained for Polymer 2, as described in Example 3(b).

FIG. 4 is a chromatogram obtained by steric exclusion chromatography for Polymer 4, as described in Example 3(d).

FIG. 5 is a proton nuclear magnetic resonance spectrum of a polymer obtained by the polymerization of diethylene glycol with lithium bis(chlorosulfonyl)imide, as described in Example 3(e).

FIG. 6 is a proton nuclear magnetic resonance spectrum obtained for Polymer 5, as described in Example 3(e).

FIG. 7 is a carbon-13 nuclear magnetic resonance (¹³C NMR) spectrum obtained for Polymer 5, as described in Example 3(e).

FIG. 8 is a fluorine nuclear magnetic resonance (¹⁹F NMR) spectrum obtained for Polymer 5, as described in Example 3(e).

FIG. 9 is a graph showing the results of the differential scanning calorimetry analysis obtained for Polymer 5, as described in Example 3(e).

FIG. 10 is a graph showing the results of ionic conductivity (S·cm⁻¹) as a function of temperature (1000/T, K⁻¹) for Cell 1, as described in Example 4(h).

FIG. 11 is a graph showing the results of ionic conductivity (S·cm⁻¹) as a function of temperature (1000/T, K⁻¹) for Cell 2, as described in Example 4(h).

FIG. 12 is a graph showing the results of ionic conductivity (S·cm⁻¹) as a function of temperature (1000/T, K⁻¹) for Cell 3, as described in Example 4(h).

FIG. 13 is a graph showing the results of ionic conductivity (S·cm⁻¹) as a function of temperature (1000/T, K⁻¹) for Cell 4, as described in Example 4(h).

FIG. 14 is a graph showing the results of ionic conductivity (S·cm⁻¹) as a function of temperature (1000/T, K⁻¹) for Cell 5 (comparative cell), as described in Example 4(h).

FIG. 15 is a graph showing the results of ionic conductivity (S·cm⁻¹) as a function of temperature (1000/T, K⁻¹) for Cell 6 (comparative cell), as described in Example 4(h).

FIG. 16 presents cyclic voltammograms obtained for Cell 7 (comparative cell) (solid line) recorded at a scan rate of 0.067 mV/s and for Cell 8 (comparative cell) (dashed line) recorded at a scan rate of 0.05 mV/s between 2.7 V and 4.3 V vs Li/Li⁺, as described in Example 5(c).

FIG. 17 presents a cyclic voltammogram obtained for Cell 7 (comparative cell) recorded at a scan rate of 0.067 mV/s between 2.5 V and 5 V vs Li/Li⁺, as described in Example 5(c).

FIG. 18 presents cyclic voltammograms obtained for Cell 9 (solid line) and for Cell 10 (dashed line) recorded at a scan rate of 0.067 mV/s between 2.5 V and 5 V vs Li/Li⁺, as described in Example 5(c).

FIG. 19 presents cyclic voltammograms obtained for Cell 7 (comparative cell) (dash dot dot line), for Cell 10 (line dot dash), for Cell 9 (dashed line) and for Cell 11 (comparative cell) (solid line) recorded at a scan rate of 0.067 mV/s between 2.5 V and 5 V vs Li/Li⁺, as described in Example 5(c).

### DETAILED DESCRIPTION

The following detailed description and examples are for illustrative purposes only and should not be construed as further limiting the scope of the invention.

All technical and scientific terms and expressions used herein have the same definitions as those generally understood by the person skilled in the art of the present technology. The definition of some terms and expressions used herein is nevertheless provided below.

When the term “approximately” or its equivalent term “about” are used herein, it means in the region of, or around. For example, when the terms “approximately” or “about” are used in relation to a numerical value, they may modify it above and below by a 10% variation from the nominal value. This term may also take into account, for example, rounding or experimental error due to the limitations of a measuring device.

When a range of values is mentioned herein, the lower and upper limits of the range are, unless otherwise specified, always included in the definition. When a range of values is mentioned in the present application, all intermediate ranges and subranges, as well as individual values included in these ranges, are included in the definition.

For more clarity, the expression “monomeric units derived from” and equivalent expressions, as used herein, refer to polymer repeating units obtained from the polymerization of a polymerizable monomer.

The expression “repeating unit” as used herein refers to a sequence of repeating units forming part of a polymer chain.

The term “fragment” as used herein in connection with a polymer sequence, refers to a portion of a polymer comprising a repeating unit and optionally a terminal group.

The chemical structures described herein are drawn according to the conventions of the field. Also, when an atom, such as a carbon atom, as drawn appears to include an incomplete valence, then it is assumed that the valence is satisfied by one or more hydrogen atoms even if they are not explicitly drawn.

For greater certainty, in the present document, when a formula denotes a polymer repeating unit or fragment, unless defined, for example, by an OH, NH₂ group, etc., the end of the link extending beyond the bracket(s) of the formula:

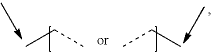

is not necessarily a methyl group and is rather defined as being the remainder of the polymer, the definition of the group outside the bracket remaining open. For example, this group may represent a group X₁, X₂, X₃, X₄, R₆ or R₇ as defined herein, the residue of an initiator, or another polymer fragment.

As used herein, the term “alkyl” refers to saturated hydrocarbons having between one and ten carbon atoms, including linear or branched alkyl groups. Non-limiting examples of alkyl groups may include methyl, ethyl, propyl, butyl, pentyl, hexyl, heptyl, octyl, nonyl, decyl, isopropyl, tert-butyl, sec-butyl, isobutyl, and so forth. When the alkyl group is located between two functional groups, then the term alkyl also encompasses alkylene groups such as methylene, ethylene, propylene, and so forth. The terms “Cₘ-Cₙalkyl” and “Cₘ-Cₙalkylene” respectively refer to an alkyl or alkylene group having from the indicated number “m” to the indicated number “n” of carbon atoms.

As used herein, the term “aryl” refers to functional groups comprising rings having aromatic character having from 6 to 14 ring atoms, preferably 6 ring atoms. The term “aryl” refers to both monocyclic and polycyclic conjugated systems. The term “aryl” also includes substituted or unsubstituted groups. Examples of aryl groups include, without limitation, phenyl, benzyl, phenethyl, 1-phenylethyl, tolyl, naphthyl, biphenyl, terphenyl, indenyl, benzocyclooctenyl, benzocycloheptenyl, azulenyl, acenaphthylenyl, fluorenyl, phenanthrenyl, anthracenyl, perylenyl, and so forth.

The present technology relates to an ionic polymer comprising at least one repeating unit comprising the reaction product between at least one compound of Formula 1 comprising at least two functional groups and a metal bis(halosulfonyl)imide of Formula 2:

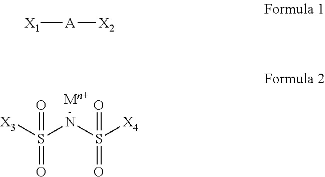

wherein,
A is a substituted or unsubstituted organic group selected from a linear or branched C₁-C₁₀alkylene, a linear or branched C₁-C₁₀alkyleneoxyC₁-C₁₀alkylene, a linear or branched poly(C₁-C₁₀alkyleneoxy)C₁-C₁₀alkylene, a linear or branched polyether and a linear or branched polyester;
X₁ and X₂ are functional groups independently and at each occurrence selected from a hydroxyl group, a thiol group and an amine group;
X₃ and X₄ are halogen atoms each independently selected from F, Cl, Br and I; and
Mⁿ⁺ is an alkali or alkaline earth metal ion selected from the group consisting of Na⁺, K⁺, Li⁺, Ca²⁺ and Mg²⁺ ions.

According to one example, X₁ and X₂ may be functional groups independently and at each occurrence selected from a hydroxyl group (OH), a thiol group (SH) and a primary amine group (NH₂). According to one variant of interest, X₁ and X₂ may be functional groups independently and at each occurrence selected from a hydroxyl group and a primary amine group.

According to another example, X₁ and X₂ may be the same, for example, X₁ and X₂ are both hydroxyl groups, or both thiol groups, or both primary amine groups. According to one variant of interest, X₁ and X₂ are both hydroxyl groups. According to another variant of interest, X₁ and X₂ are both primary amine groups.

According to another example, X₃ and X₄ may be the same, for example, X₃ and X₄ are both chlorine atoms.

According to another example, Mⁿ⁺ may be an alkali metal ion selected from the group consisting of Na⁺, K⁺ and Li⁺ ions, for example, Mⁿ⁺ is a Li⁺ ion.

For example, X₃ and X₄ are both chlorine atoms and Mⁿ⁺ is a Li⁺ ion, i.e., the metal bis(halosulfonyl)imide of Formula 2 is lithium bis(chlorosulfonyl)imide.

According to another example, A is a substituted or unsubstituted organic group selected from a linear or branched C₂-C₁₀alkylene, a linear or branched C₂-C₁₀alkyleneoxyC₂-C₁₀alkylene, a linear or branched poly(C₂-C₁₀alkyleneoxy)C₂-C₁₀alkylene, a linear or branched polyether and a linear or branched polyester.

According to another example, A is an optionally substituted linear or branched C₁-C₁₀alkylene and the compound of Formula 1 is a compound of Formula 3:

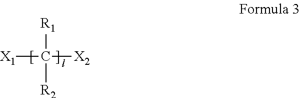

wherein,
X₁ and X₂ are as herein defined;
R₁ and R₂ are independently and at each occurrence selected from a hydrogen atom, a hydroxyl group, a thiol group, an amine group, a halogen atom selected from F, Cl, Br and I, and linear or branched substituents selected from C₁-C₁₀alkyl, C₁-C₁₀alkyl-acrylate, C₁-C₁₀alkyl-methacrylate, oxycarbonyl-C₁-C₁₀alkyl-methacrylate, oxycarbonyl-C₁-C₁₀alkyl-acrylate, aminocarbonyl-C₁-C₁₀alkyl-methacrylate, aminocarbonyl-C₁-C₁₀alkyl-acrylate, oxycarbonylamino-C₁-C₁₀alkyl-methacrylate, and oxycarbonylamino-C₁-C₁₀alkyl-acrylate; and
l is a number in the range of 1 to 10.

According to another example, R₁ and R₂ are independently and at each occurrence selected from a hydrogen atom, a hydroxyl group, a thiol group, an amine group, a fluorine atom and linear or branched substituents selected from C₁-C₁₀alkyl-acrylate, C₁-C₁₀alkyl-methacrylate, oxycarbonylamino-C₁-C₁₀alkyl-methacrylate and oxycarbonylamino-C₁-C₁₀alkyl-acrylate.

According to another example, R₁ and R₂ are independently and at each occurrence selected from a hydrogen atom, a hydroxyl group, a thiol group, a primary amine group, a fluorine atom, and linear or branched substituents selected from C₁-C₁₀alkyl-acrylate, C₁-C₁₀alkyl-methacrylate, oxycarbonylamino-C₁-C₁₀alkyl-methacrylate and oxycarbonylamino-C₁-C₁₀alkyl-acrylate.

According to another example, l is a number in the range of 2 to 10.

According to another example, A is a linear or branched and optionally substituted poly(C₁-C₁₀alkyleneoxy)C₁-C₁₀alkylene, for example the compound of Formula 1 may be a compound of Formula 4:

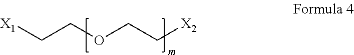

wherein,
X₁ and X₂ are as herein defined; and
m is a number in the range of 1 to 68.

According to one variant of interest, X₁ and X₂ are both hydroxyl groups or are both amine groups and the compound of Formula 1 is of Formulae 4(a) or 4(b):

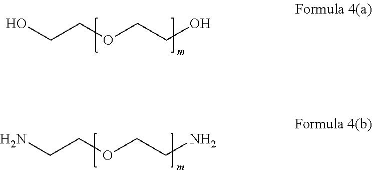

wherein,
m is a number in the range of 1 to 6.

According to another variant of interest, the compound of Formula 1 may be a JEFFAMINE® D series product and the compound is of Formula 4 (c):

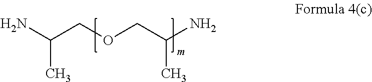

wherein,
m is a number in the range of 1 to 68.

According to one example, the JEFFAMINE® D series product may be JEFFAMINE® D-230, where m is about 2.5 and the number average molecular weight of the polyether diamine is about 230 g/mol.

According to another example, the JEFFAMINE® D series product may be JEFFAMINE® D-400, where m is about 6.1 and the number average molecular weight of the polyether diamine is about 430 g/mol.

According to another example, the JEFFAMINE® D series product may be JEFFAMINE® D-2000, where m is about 33 and the number average molecular weight of the polyether diamine is about 2,000 g/mol.

According to another example, the JEFFAMINE® D series product may be JEFFAMINE® D-4000, where m is about 68 and the number average molecular weight of the polyether diamine is about 4,000 g/mol.

According to another example, A is a linear or branched and optionally substituted polyether. According to one example, the optionally substituted polyether may be based on propylene oxide (PO), ethylene oxide (EO) or a mixture of PO/EO. For example, A is an optionally substituted polyether principally based on polyethylene glycol (PEG) and the compound of Formula 1 is a compound of Formula 5:

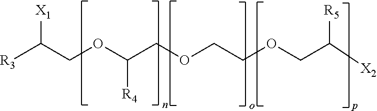

wherein,
X₁ and X₂ are as herein defined;
R₃, R₄ and R₅ are independently and at each occurrence selected from C₁-C₁₀alkyl groups;
n, o and p are selected such that the number average molecular weight of the polyether is between about 220 g/mol and about 2,000 g/mol, upper and lower limits included;
n and p are selected such that the sum (n+p) is in the range of about 1 to about 6; and
o is in the range of about 2 to about 39.

According to one variant of interest, the compound of Formula 1 is a compound of Formula and may be a JEFFAMINE® ED series product, the compound being of Formula 5(a):

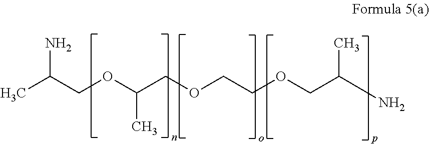

wherein,
n, o and p are selected such that the number average molecular weight of the polyether is between about 220 g/mol and about 2,000 g/mol, upper and lower limits included;
n and p are selected such that the sum (n+p) is in the range of about 1 to about 6; and
o is a number in the range of about 2 to about 39.

According to one example, the JEFFAMINE® ED series product may be JEFFAMINE® HK-511, where o is about 2, the sum (n+p) is about 1.2 and the number average molecular weight of the polyether diamine is about 220 g/mol.

According to another example, the JEFFAMINE® ED series product may be JEFFAMINE® ED-2003, where o is about 39, the sum (n+p) is about 6, and the number average molecular weight of the polyether diamine is about 2,000 g/mol.

According to another example, the JEFFAMINE® ED series product may be JEFFAMINE® ED-900, where o is about 12.5, the sum (n+p) is about 6 and the number average molecular weight of the polyether diamine is about 900 g/mol.

According to another example, the JEFFAMINE® ED series product may be JEFFAMINE® ED-600, where o is about 9, the sum (n+p) is about 3.6 and the number average molecular weight of the polyether diamine is about 600 g/mol.

According to one variant of interest, the JEFFAMINE® ED series product may be selected from the group consisting of JEFFAMINE® ED-600, ED-900 and ED-2003.

According to another example, A is a linear or branched and optionally substituted poly(C₁-C₁₀alkyleneoxy)-C₁-C₁₀alkylene, wherein the compound of Formula 1 can be a compound of Formula 6:

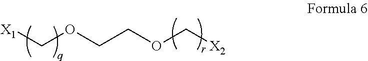

wherein,
X₁ and X₂ are as herein defined; and
q and r are numbers in the range of 1 to 10.

According to one variant of interest, the compound of Formula 1 is a compound of Formula 6 and may be a JEFFAMINE® EDR series product of Formula 6(a):

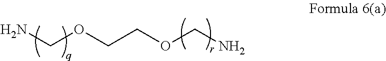

wherein,
X₁, X₂, q and r are as herein defined.

According to one example, the JEFFAMINE® EDR series product may be JEFFAMINE® EDR-148, where q and r are about 2 and the number average molecular weight of the polyether diamine is about 148 g/mol.

According to another example, the JEFFAMINE® EDR series product may be JEFFAMINE® EDR-176, where q and r are about 3 and the number average molecular weight of the polyether diamine is about 176 g/mol.

According to another example, A is an optionally substituted aliphatic polyester such as polycaprolactone and, for example, the compound of Formula 1 is a compound of Formula 7:

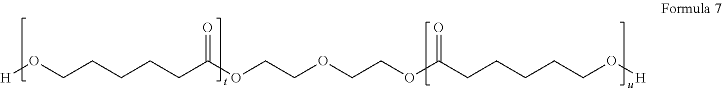

wherein,
t and u are numbers between 1 and 10.

According to another example, the compound of Formula 1 including at least two functional groups can be an alcohol (or polyalcohol) including at least two hydroxyl groups, a glycol ether, or a polyol such as a diol (or glycol), triol, tetraol, pentol, hexol, heptol and so forth. For example, the compound including at least two hydroxyl groups may be a linear or branched diol (or glycol), and may be aliphatic or aromatic, for example, all diols (or glycols) are contemplated.

Non-limiting examples of compounds including at least two hydroxyl groups include glycerol (glycerin), alkane diols, 1,3-propanediol, 1,4-butanediol, 1,5-pentanediol, 1,6-hexanediol, 1,8-octanediol, 1,2-propanediol (or propylene glycol (PG)), 1,2-butanediol, 2,3-butanediol (or dimethylene glycol), 1,3-butanediol (or butylene glycol), 1,2-pentanediol, etohexadiol, p-menthane-3,8-diol, 2-methyl-2,4-pentanediol, polycaprolactone diol, ethylene glycol (1,2-ethanediol), diethylene glycol (or ethylene diglycol), triethylene glycol, tetraethylene glycol, pentaethylene glycol, polyethylene glycol, and other similar glycols and diols, or combinations thereof. For example, the compound including at least two hydroxyl groups may be selected from glycerol, diethylene glycol, ethylene glycol, propane diol, triethylene glycol, tetraethylene glycol, 2,2,3,3,4,4,5,5-octafluoro-1,6-hexanediol and polycaprolactone diol.

According to one variant of interest, the compound including at least two hydroxyl groups may be glycerol. According to another variant of interest, the compound including at least two hydroxyl groups may be diethylene glycol. According to another variant of interest, the compound including at least two hydroxyl groups may be 2,2,3,3,4,4,5,5-octafluoro-1,6-hexanediol.

According to another example, the compound including at least two functional groups can be a polyamine including at least two amine groups such as a diamine, a triamine and so forth. For example, the compound including at least two amine groups can be a linear or branched diamine and can be aliphatic or aromatic, for example, all diamines are contemplated. Non-limiting examples of compounds including at least two amine groups include propane-1,2,3-triamine, alkane diamines, 1,3-propanediamine, 1,4-butanediamine, 1,5-pentanediamine, 1,6-hexanediamine, 1,8-octanediamine, 1,2-propanediamine, 1,2-butanediamine, 2,3-butanediamine, 1,3-butanediamine, 1,2-pentanediamine, 2,4-diamino-2-methylpentane, ethylenediamine (1,2-diaminoethane), 1,8-diamino-3,6-dioxaoctane, 1,11-diamino-3,6,9-trioxaundecane, 4,9-dioxa-1,12-dodecanediamine, 1,14-diamino-3,6,9,12-tetraoxatetradecane, poly(ethylene glycol) diamine (or PEG-diamine), JEFFAMINE® D series products (amine-terminated polypropylene glycols), JEFFAMINE® ED series products (mainly polyethylene glycol-based diamines), JEFFAMINE® EDR series products, and other similar polyamines, or combinations thereof.

According to one variant of interest, the compound including at least two amine groups may be a PEG-diamine of the formula H₂NCH₂CH₂(OCH₂CH₂)ₙNH₂, where n is 1 or 2. According to another variant of interest, the compound including at least two amine groups may be a JEFFAMINE® ED series product (or O,O′-bis(2-aminopropyl) polypropylene glycol-block-polyethylene glycol-block-polypropylene glycol). For example, the JEFFAMINE® ED series product may be selected from JEFFAMINE® ED-600, ED-900 and ED-2003.

The present technology therefore also relates to an ionic polymer comprising at least one repeating unit of Formula 8(a) and/or is a polymer of Formula 8(b):

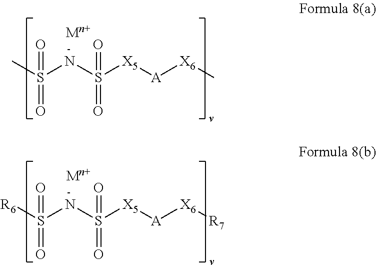

wherein,
A is a substituted or unsubstituted organic group independently and at each occurrence selected from a linear or branched C₁-C₁₀alkylene, a linear or branched C₁-C₁₀alkyleneoxyC₁-C₁₀alkylene, a linear or branched poly(C₁-C₁₀alkyleneoxy)C₁-C₁₀alkylene, a linear or branched polyether and a linear or branched polyester;
X₅ and X₆ are each independently selected from an oxygen atom, a sulfur atom and an —NH group;
R₆ is selected from a hydroxyl group, a thiol group, an amine group and a R₇-X₅-A-X₆— group;
R₇ is a crosslinkable group independently at each occurrence selected from acrylate, methacrylate, C₁-C₁₀alkyl-acrylate, C₁-C₁₀alkyl-methacrylate, carbonyl-C₁-C₁₀alkyl-methacrylate carbonyl-C₁-C₁₀alkyl-acrylate, carbonyloxy-C₁-C₁₀alkyl-methacrylate, carbonyloxy-C₁-C₁₀alkyl-acrylate, carbonylamino-C₁-C₁₀alkyl-methacrylate and carbonylamino-C₁-C₁₀alkyl-acrylate;
Mⁿ⁺ is an alkali or alkaline earth metal ion selected from the group consisting of Na⁺, K⁺, Li⁺, Ca²⁺ and Mg²⁺ ions; and
v is a number selected such that the number average molecular weight of the ionic polymer is between about 8,000 g/mol and about 150,000 g/mol, upper and lower limits included.

According to one example, X₅ and X₆ may be the same. For example, X₅ and X₆ are both oxygen atoms, or both sulfur atoms, or both NH groups. According to one variant of interest, X₅ and X₆ are both oxygen atoms. According to another variant of interest, X₅ and X₆ are both NH groups.

According to another example, the number average molecular weight of the ionic polymer is between about 8,000 g/mol and about 60,000 g/mol, upper and lower limits included.

According to another example, the ionic polymer comprises at least one repeating unit of Formula 9:

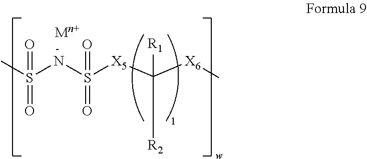

wherein,
Mⁿ⁺, R₁, R₂, l, X₅ and X₆ are as herein defined; and
w is a number selected such that the number average molecular weight of the ionic polymer is between about 8,000 g/mol and about 150,000 g/mol, upper and lower limits included.

According to one example, the number average molecular weight of the ionic polymer is between about 8,000 g/mol and about 60,000 g/mol, upper and lower limits included.

According to another example, the ionic polymer comprises at least one repeating unit of Formula 10:

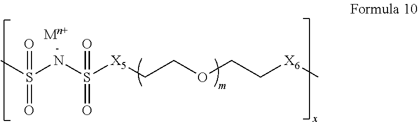

wherein,
Mⁿ⁺, m, X₅ and X₆ are as herein defined; and
x is a number selected such that the number average molecular weight of the ionic polymer is between about 8,000 g/mol and about 150,000 g/mol, upper and lower limits included.

According to one example, the number average molecular weight of the ionic polymer is between about 8,000 g/mol and about 60,000 g/mol, upper and lower limits included.

According to one variant of interest, X₅ and X₆ are both oxygen atoms or are both NH groups and the ionic polymer is of Formula 10(a) or 10(b):

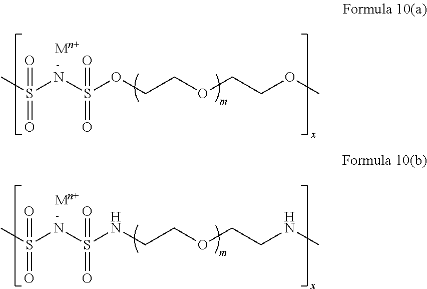

wherein,
Mⁿ⁺, m, and x are as herein defined.

According to another example, the ionic polymer comprises at least one repeating unit of Formula 11:

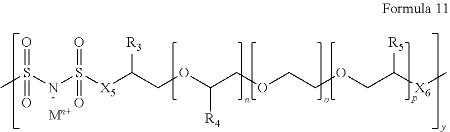

wherein,
Mⁿ⁺, R₃, R₄, R₅, n, o, p X₅ and X₆ are as herein defined; and
y is a number selected such that the number average molecular weight of the ionic polymer is between about 8,000 g/mol and about 150,000 g/mol, upper and lower limits included.

According to one example, the number average molecular weight of the ionic polymer is between about 8,000 g/mol and about 60,000 g/mol, upper and lower limits included.

According to one variant of interest, X₅ and X₆ are both NH groups, R₃, R₄ and R₅ are methyl groups and the ionic polymer is of Formula 11(a):

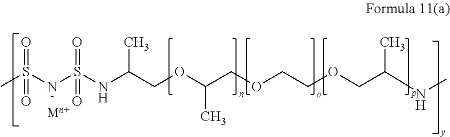

wherein,
Mⁿ⁺, n, o, p and y are as herein defined.

According to another example, the ionic polymer comprises at least one repeating unit of Formula 12:

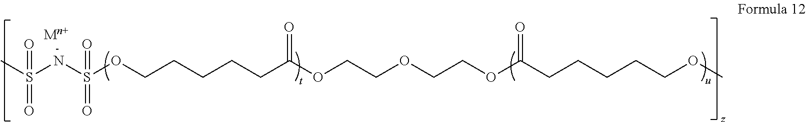

wherein,
Mⁿ⁺, t and u are as herein defined; and
z is a number selected such that the number average molecular weight of the ionic polymer is between about 8,000 g/mol and about 150,000 g/mol, upper and lower limits included.

According to one example, the number average molecular weight of the ionic polymer is between about 8,000 g/mol and about 60,000 g/mol, upper and lower limits included.

According to another example, the ionic polymer may be an ionic prepolymer. According to another example, the ionic polymer may be an ionic copolymer.

The technology also relates to the ionic polymer as defined above, wherein said ionic polymer is a crosslinked ionic polymer. According to one example, the ionic polymer may further comprise at least one crosslinkable functional group. According to another example, the crosslinkable functional group may be a terminal group and be present at least on one end of the carbon chain of the ionic polymer. According to another example, the crosslinkable functional group may be present on a side chain of the carbon chain of the ionic polymer. According to another example, the crosslinkable functional group may be present on at least one end of the carbon chain of the ionic polymer and on a side chain thereof. For example, the crosslinkable functional group may be selected from cyanate, acrylate, and methacrylate groups. According to one variant of interest, the crosslinkable functional group may be selected from C₁-C₁₀alkyl-acrylate, C₁-C₁₀alkyl-methacrylate, oxycarbonylamino-C₁-C₁₀alkyl-methacrylate, oxycarbonylamino-C₁-C₁₀alkyl-acrylate, carbonylamino-C₁-C₁₀alkyl-methacrylate and carbonylamino-C₁-C₁₀alkyl-acrylate groups.

According to an example of interest, the ionic polymer may be an ionic polymer comprising at least one fragment of Formula 13:

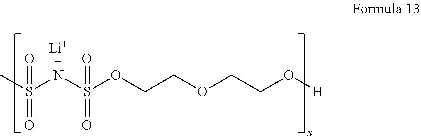

wherein,
x is as herein defined.

According to another example of interest, the ionic polymer may be an ionic polymer comprising at least one fragment of Formula 14:

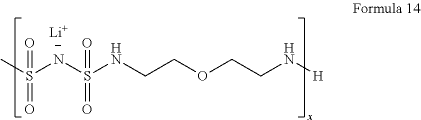

wherein,
x is as herein defined.

According to another example of interest, the ionic polymer may be an ionic polymer comprising at least one fragment of Formula 15:

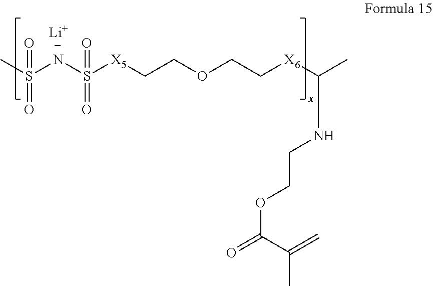

wherein,
X₅, X₅ and x are as herein defined.

According to one example, the ionic polymer may be an ionic polymer comprising at least one fragment of Formula 15(a):

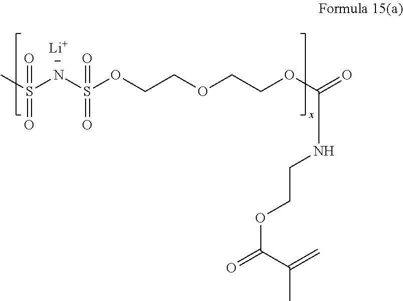

wherein,
x is as herein defined.

According to another example, the ionic polymer may be an ionic polymer comprising at least one fragment of Formula 15(b):

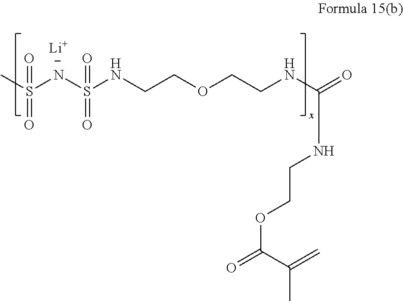

wherein,
x is as herein defined.

According to another example of interest, the ionic polymer may be an ionic polymer comprising at least one fragment of Formula 16:

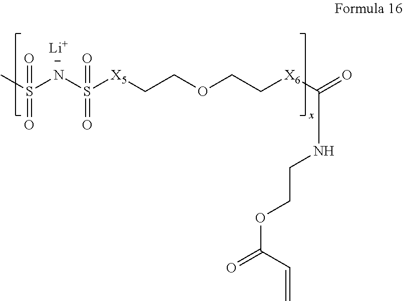

wherein,
x is as herein defined.

According to one example, the ionic polymer may be an ionic polymer comprising at least one fragment of Formula 16(a):

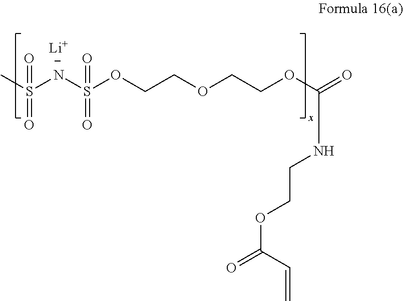

wherein,
x is as herein defined.

According to another example, the ionic polymer may be an ionic polymer comprising at least one fragment of Formula 16(b):

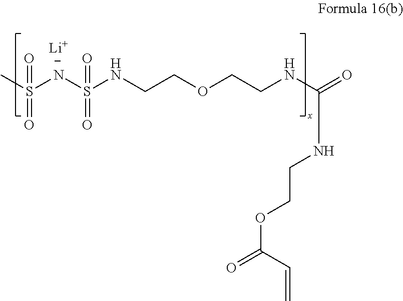

wherein,
x is as herein defined.

According to another example of interest, the ionic polymer may be an ionic polymer comprising at least one fragment of Formula 17:

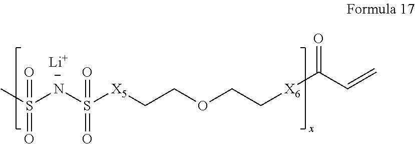

wherein,
X₅, X₆ and x are as herein defined.

According to one example, the ionic polymer may be an ionic polymer comprising at least one fragment of Formula 17(a):

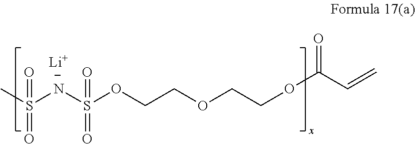

wherein,
x is as herein defined.

According to another example, the ionic polymer may be an ionic polymer comprising at least one fragment of Formula 17(b):

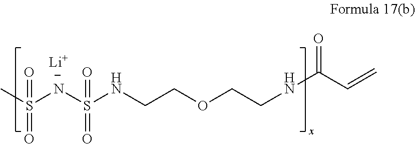

wherein,
x is as herein defined.

According to another example of interest, the ionic polymer may be an ionic polymer comprising at least one fragment of Formula 18:

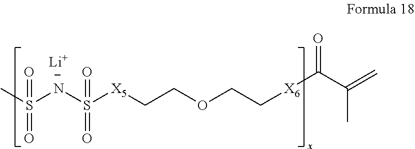

wherein,
X₅, X₆ and x are as herein defined.

According to one example, the ionic polymer may be an ionic polymer comprising at least one fragment of Formula 18(a):

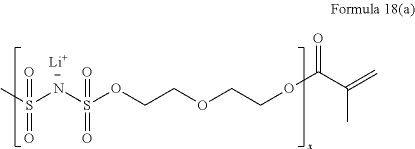

wherein,
x is as herein defined.

According to another example, the ionic polymer may be an ionic polymer comprising at least one fragment of Formula 18(b):

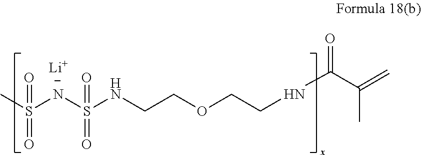

wherein,
x is as herein defined.

According to another example of interest, the ionic polymer may be an ionic polymer comprising at least one fragment of Formula 19:

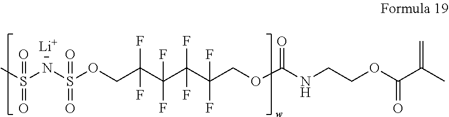

wherein,
w is as herein defined.

According to another example of interest, the ionic polymer may be an ionic polymer comprising at least one fragment of Formula 20:

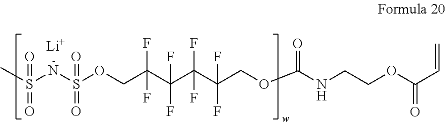

wherein,
w is as herein defined.

According to another example of interest, the ionic polymer may be an ionic polymer comprising at least one fragment of Formula 21:

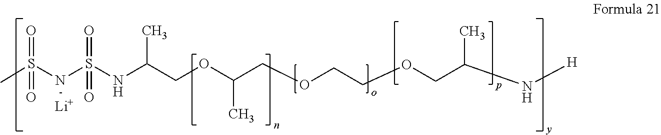

wherein,
n, o, p and y are as herein defined.

According to another example of interest, the ionic polymer may be an ionic polymer comprising at least one fragment of Formula 22:

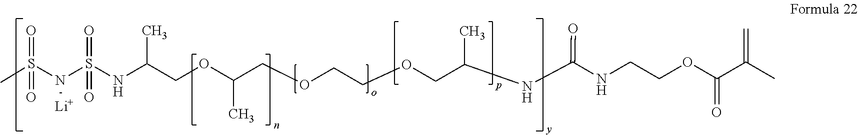

wherein,
n, o, p and y are as herein defined.

According to another example of interest, the ionic polymer may be an ionic polymer comprising at least one fragment of Formula 23:

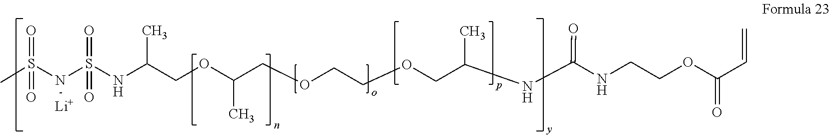

wherein,
n, o, p and y are as herein defined.

According to another example of interest, the ionic polymer may be an ionic polymer comprising at least one fragment of Formula 24:

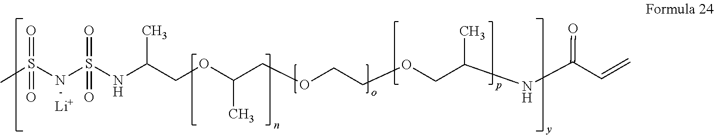

wherein,
n, o, p and y are as herein defined.

According to another example of interest, the ionic polymer may be an ionic polymer comprising at least one fragment of Formula 25:

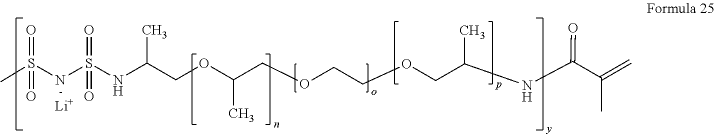

wherein,
n, o, p and y are as herein defined.

According to another example of interest, the ionic polymer may be an ionic polymer comprising at least one fragment of Formula 26:

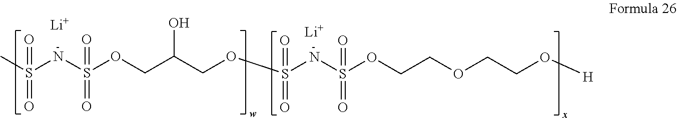

wherein,
w and x are as herein defined.

According to another example of interest, the ionic polymer may be an ionic polymer comprising at least one fragment of Formula 27:

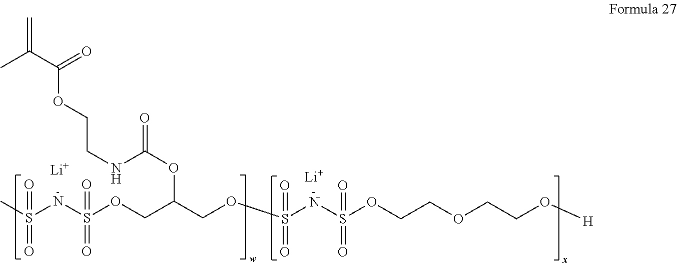

wherein,
w and x are as herein defined.

According to another example of interest, the ionic polymer may be an ionic polymer comprising at least one fragment of Formula 28:

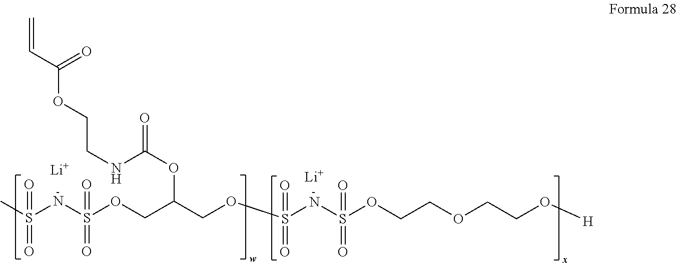

wherein,
w and x are as herein defined.

The present technology also relates to a polymer composition comprising an ionic polymer as defined above.

According to one example, the polymer composition or ionic polymer may optionally further include at least one additional component or additive such as ionic conductors, inorganic particles, glass particles, ceramic particles (for example, nanoceramics), salts, and other similar additives, or combinations thereof. For example, the additional component or additive may be a filler additive and may include metal oxide particles or nanoparticles. For example, the filler additive may include particles or nanoparticles of titanium dioxide (TiO₂), alumina (Al₂O₃) and/or silicon dioxide (SiO₂).

The technology also relates to a process for preparing an ionic polymer or polymer composition as defined herein, the process comprising the following steps:
(i) preparing a metal bis(halosulfonyl)imide of Formula 2; and
(ii) reacting at least one compound of Formula 1 including at least two functional groups as described above with said metal bis(halosulfonyl)imide of Formula 2.

According to one example, the process further comprises a step of preparing a bis(halosulfonyl)imide. For example, the step of preparing a bis(halosulfonyl)imide may be carried out by reacting sulfamic acid (H₃NSO₃) with a halosulfonic acid of formula HSO₃X₃ (wherein X₃ is as defined above) in the presence of at least one halogenating agent. For example, the preparation of a bis(halosulfonyl)imide may be carried out by a process as described by Beran et al., and may be as illustrated in Scheme 1 below (Beran et al., Zeitschrift für anorganische and allgemeine Chemie 631.1 (2005): 55-59):

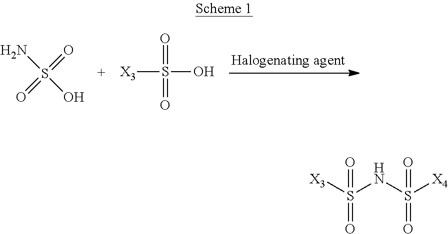

wherein X₃ and X₄ are as defined above.

According to one variant of interest, the bis(halosulfonyl)imide is a bis(chlorosulfonyl)imide (HN(SO₂Cl)₂).

According to one example, bis(chlorosulfonyl)imide can be prepared by the reaction of sulfamic acid with chlorosulfonic acid (HSO₃Cl) in the presence of at least one halogenating agent.

According to another example, the step of preparing the bis(halosulfonyl)imide may further comprise a purification step. For example, the purification step may be carried out by any known compatible purification methods. For example, the purification step may be carried out by distillation.

According to another example, the halogenating agent may be selected from any known compatible halogenating agents. For example, the halogenating agent may also serve as a reaction medium and/or solvent and may be selected for its ease of isolation during an optional subsequent purification step. For example, the halogenating agent may be selected from phosphorus trichloride (PCl₃), phosphorus pentachloride (PCl₅), thionyl chloride (SOCl₂), thionyl fluoride (SOF₂), phosphorus oxychloride (POCl₃) and oxalyl chloride ((COCl)₂). For example, the halogenating agent is a chlorinating agent. According to one variant of interest, the halogenating agent is thionyl chloride.

Without wishing to be bound by theory, thionyl chloride can, for example, react with the amine group to form a (—N═S═O) group. For example, the reaction mechanism between sulfamic acid and chlorosulfonic acid in the presence of thionyl chloride could therefore be as illustrated in Scheme 2:

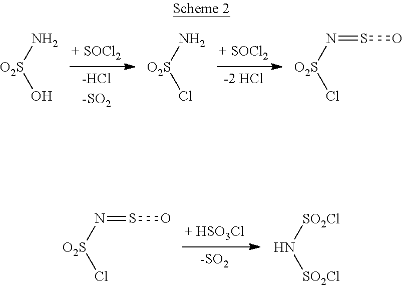

For example, one equivalent of sulfamic acid reacts with one equivalent of chlorosulfonic acid in the presence of two equivalents of thionyl chloride to form a bis(chlorosulfonyl)imide.

According to another example, the halogenating agent (for example, thionyl chloride) may be added in excess. For example, the amount of halogenating agent may be in the range of from about 2 equivalents to about 5 equivalents in relation to sulfamic acid, upper and lower limits included. For example, the amount of halogenating agent may be in the range of from about 2 equivalents to about 4 equivalents, or from about 2 equivalents to about 3 equivalents, or from about 2 equivalents to about 2.75 equivalents, or from about 2 equivalents to about 2.5 equivalents per equivalent of sulfamic acid, upper and lower limits included. According to one variant of interest, the amount of halogenating agent is of about 2.75 equivalents in relation to the sulfamic acid.

According to another example, the reaction between the sulfamic acid and the halosulfonic acid in the presence of at least one halogenating agent is carried out at a sufficiently high temperature and for a sufficient time to allow for a substantially complete reaction. For example, the reaction between the sulfamic acid and the halosulfonic acid in the presence of at least one halogenating agent is carried out at a temperature in the range of from about 60° C. to about 150° C., upper and lower limits included. For example, the step of preparing a bis(halosulfonyl)imide may be carried out at a temperature in the range of from about 70° C. to about 145° C., or from about 80° C. to about 140° C., or from about 90° C. to about 100° C., or from about 110° C. to about 140° C., or from about 120° C. to about 140° C., or from about 125° C. to about 140° C., or from about 125° C. to about 135° C., upper and lower limits included. According to one variant of interest, the step of preparing a bis(halosulfonyl)imide may be carried out at a temperature of about 130° C., for example, for a period of about 24 hours.

According to another example, the metal bis(halosulfonyl)imide is prepared by a metalation reaction of a bis(halosulfonyl)imide. For example, the step of preparing a metal bis(halosulfonyl)imide or the metalation step may be performed by the reaction between a bis(halosulfonyl)imide and at least one metalating agent in the presence of a solvent. For example, the step of preparing a metal bis(halosulfonyl)imide or the metalation step may be carried out by a process as illustrated in Scheme 3:

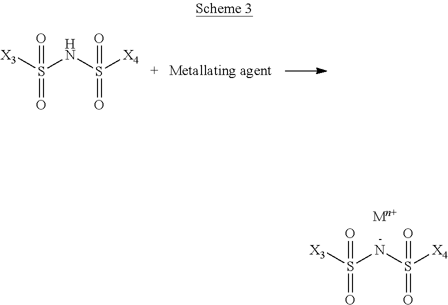

wherein X₃, X₄ and Mⁿ⁺ are as defined above.

According to another example, the metalating agent may be selected from all known compatible metalating agent. According to one variant of interest, the metal of the metalating agent is an alkali or alkaline earth metal selected from lithium, sodium, potassium, calcium, and magnesium. For example, the metal of the metalating agent is an alkali metal selected from lithium, sodium, and potassium. According to another variant of interest, the alkali metal is lithium, the metalating agent is a lithiating agent, and the metalating step is a lithiation step. For example, the lithiating agent may be selected for its ability to readily deprotonate and lithiate the bis(halosulfonyl)imide, for example, the bis(chlorosulfonyl)imide. According to one variant of interest, the lithium bis(halosulfonyl)imide may be prepared by a process as described by Paul et al. (Paul et al., Journal of Inorganic and Nuclear Chemistry 39.3 (1977): 441-442).

Non-limiting examples of lithiating agents include lithium hydroxide (LiOH), lithium carbonate (Li₂CO₃), lithium hydrogen carbonate (LiHCO₃), lithium hydride (LiH), metallic lithium, lithium chloride (LiCl), lithium bromide (LiBr), lithium iodide, a lithium carboxylate of formula RCO₂Li (wherein R is a linear or branched C₁-C₁₀alkyl group or an aromatic hydrocarbon), and lithium oxalate (C₂Li₂O₄). According to one variant of interest, the lithiating agent is lithium chloride.

According to another example, the solvent used in the step of preparing the metal bis(halosulfonyl)imide or the metalation step may be an organic solvent, for example, a polar aprotic solvent. For example, the solvent may be selected from the group consisting of N,N-dimethylformamide (DMF), N-methyl-2-pyrrolidone (NMP), dimethylacetamide (DMAc), tetrachloromethane, chloroform, acetonitrile, tetrahydrofuran (THF), and a miscible combination of at least two thereof. According to one variant of interest, the solvent for the metalation reaction is N,N-dimethylformamide. For example, the solvent may also act as an activator for the subsequent polymerization reaction. According to one example, the N,N-dimethylformamide may form a complex with the metal bis(halosulfonyl)imide thereby substantially improving the yield of the subsequent step of reacting at least one compound of Formula 1 as described above with the metal bis(halosulfonyl)imide of Formula 2 as defined herein. For example, the complex may be a complex as described by Higashi et al. (Higashi et al., Journal of Polymer Science: Polymer Chemistry Edition 22, No. 7 (1984): 1653-1660).

According to another example, the metalating agent may be added in a bis(halosulfonyl)imide:metalating agent molar ratio of 1:1. Alternatively, the metalating agent may be added in excess relative to the bis(halosulfonyl)imide. For example, the amount of metalating agent may be in the range of from about 1 equivalent to about 5 equivalents per equivalent of bis(halosulfonyl)imide, upper and lower limits included. For example, the amount of metalating agent may be in the range of from about 1 equivalent to about 4 equivalents, or from about 1 equivalent to about 3 equivalents, or from about 1 equivalent to about 1.5 equivalents, or from about 1 equivalent to about 1.3 equivalents, or from about 1 equivalent to about 1.2 equivalents per equivalent of bis(halosulfonyl)imide, upper and lower limits included. According to one variant of interest, the amount of metalating agent may be in the range of from about 1 equivalent to about 1.5 equivalents per equivalent of bis(halosulfonyl)imide, upper and lower limits included.

According to another example, the step of preparing a metal bis(halosulfonyl)imide or the metalation step may be carried out at a temperature in the range of from about 20° C. to about 150° C., including the upper and lower bounds. For example, the step of preparing a metal bis(halosulfonyl)imide or the metalation step may be carried out at a temperature in the range of from about 30° C. to about 135° C., or from about 40° C. to about 130° C., or from about 50° C. to about 125° C., or from about 60° C. to about 120° C., or from about 70° C. to about 115° C., or from about 80° C. to about 110° C., or from about 90° C. to about 105° C., upper and lower limits included. According to one variant of interest, the step of preparing a metal bis(halosulfonyl)imide or the metalation step may be carried out at a temperature of about 100° C.

According to another example, the step of preparing a metal bis(halosulfonyl)imide or the metalation step may be carried out at a sufficiently high temperature and for a sufficient period of time to allow a substantially complete metalation reaction.

For example, the metalation reaction may be carried out for a period of time in the range of from about 10 hours to about 48 hours, or from about 10 hours to about 24 hours, or from about 12 hours to about 24 hours, upper and lower limits included. According to one variant of interest, the metalation reaction may be carried out for a period of time in the range of from about 12 hours to about 24 hours.

According to another example, the step of reacting at least one compound of Formula 1 including at least two functional groups as described above with the metal bis(halosulfonyl)imide of Formula 2 as defined herein is a polymerization step. For example, any compatible polymerization methods are contemplated. According to one variant of interest, the polymerization of the metal bis(halosulfonyl)imide of Formula 2 and at least one compound of Formula 1 may be carried out by polycondensation or by polyesterification, for example, by a Fischer esterification reaction (or Fischer-Speier esterification) or by a modified Steglich esterification. For example, the polycondensation may be a thermal polycondensation. According to one variant of interest, the polycondensation may be carried out by a process as described by Slavko et al. (Slavko et al., Chemical Science 8.10 (2017): 7106-7111).

According to another example, the reaction of at least one compound of Formula 1 as described above with the metal bis(halosulfonyl)imide of Formula 2 may be carried out in the presence of a solvent, for example, an organic solvent. For example, the solvent may be selected from the group consisting of N,N-dimethylformamide, N-methyl-2-pyrrolidone, di methylacetamide, tetrachloromethane, chloroform, acetonitrile, tetrahydrofuran, and a miscible combination of at least two thereof. According to one variant of interest, the solvent for the polymerization reaction is N,N-dimethylformamide. For example, the solvent may also act as an activator in the polymerization reaction.

According to another example, the polymerization may optionally be carried out in the presence of at least one polymerization catalyst and optionally at least one co-catalyst and/or optionally at least one acylation catalyst. According to another example, the polymerization can also be carried out in the presence of a base and without a polymerization catalyst. For example, any compatible polymerization catalysts, co-catalysts, acylation catalysts and bases are contemplated. According to one example, the polymerization catalyst may be an acid catalyst (for example, a Lewis acid catalyst). For example, the polymerization catalyst may be a boron-based catalyst, a boric acid-based catalyst, a boronic acid-based catalyst, or a borinic acid-based catalyst as described by Slavko et al. (Slavko et al., Chemical Science 8.10 (2017): 7106-7111). Non-limiting examples of boron-based polymerization catalysts include diarylborinic acids of formula Ar₂BOH (wherein Ar is an aryl group), diphenylborinic acid, phenylboronic acid, trifluorophenyl boronic acid, 9H-9-bora-10-thiaanthracene-9-ol, 10H-phenoxaborin-10-ol, boron tribromide (BBr₃), boron trichloride (BCl₃), acyl fluoborates, triethyloxonium fluoborate, boron trifluoride etherate, boron trifluoride (BF₃), tris(pentafluorophenyl)borane, and other similar boron-derived catalysts, or a combination of at least two thereof when compatible.

According to another example, the polymerization catalyst may be a nucleophilic catalyst. For example, the polymerization may be catalyzed by a base such as pyridine, 4-dimethylaminopyridine (DMAP) and pyridine derivatives.

According to another example, the polymerization may be carried out in the presence of a base such as triethylamine (Et₃N), N,N-diisopropylethylamine (iPr₂NEt), pyridine, and pyridine derivatives. According to one variant of interest, the base is triethylamine. For example, the base may be used to deprotonate the catalyst or regenerate it. The base may also be used to neutralize acid released during the reaction (for example, hydrochloric acid (HCl)).

According to one variant of interest, the polymerization may be carried out in the presence of triethylamine, diphenylborinic acid or trifluorophenyl boronic acid, N, N-dimethylformamide, and 4-dimethylaminopyridine. According to another variant of interest, the polymerization may be carried out in the presence of triethylamine, diphenylborinic acid or trifluorophenyl boronic acid, and N,N-dimethylformamide. Alternatively, the polymerization can be carried out in the presence of N,N-dimethylformamide and optionally a base without the addition of a catalyst, co-catalyst and/or acylation catalyst.

According to another example, the polymerization can be carried out by a process as illustrated in Scheme 4:

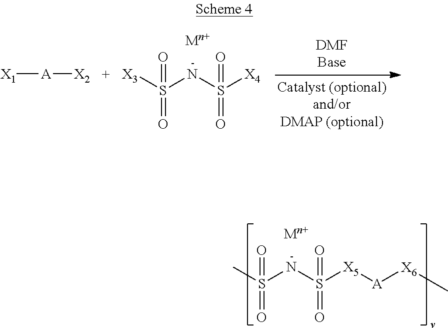

wherein, X₁, X₂, X₃, X₄, X₅, X₆, Mⁿ⁺, A and v are as defined above.

According to another example, the process further comprises a post-functionalization or post-polymerization modification step. For example, a post-functionalization of the ionic polymer is carried out in anticipation of its crosslinking. The post-functionalization step of the ionic polymer may therefore optionally be performed to functionalize the ionic polymer by introducing at least one functional group as defined above, for example, a crosslinkable functional group. The crosslinkable functional group may be present on at least one end of the carbon chain of the ionic polymer and/or on a side chain thereof. For example, at least one terminal group or substituent in the carbon chain of the ionic polymer (for example, R₁ and/or R₂) comprises functionalities allowing the crosslinking of said ionic polymer. In some cases, the presence of such a functional group may contribute to the modulation of the properties of the ionic polymer.

The optional post-functionalization or post-polymerization modification step can be carried out by the reaction between at least one functional group of the ionic polymer and at least one precursor of a crosslinkable functional group. For example, the crosslinkable functional group is selected from acrylate, methacrylate, C₁-C₁₀alkyl-acrylate, C₁-C₁₀alkyl-methacrylate, oxycarbonyl-C₁-C₁₀alkyl-methacrylate, oxycarbonyl-C₁-C₁₀alkyl-acrylate, aminocarbonyl-C₁-C₁₀alkyl-methacrylate, aminocarbonyl-C₁-C₁₀alkyl-acrylate, oxycarbonylamino-C₁-C₁₀alkyl-methacrylate, oxycarbonylamino-C₁-C₁₀alkyl-acrylate, carbonyloxy-C₁-C₁₀alkyl-methacrylate, carbonyloxy-C₁-C₁₀alkyl-acrylate, carbonylamino-C₁-C₁₀alkyl-methacrylate, and carbonylamino-C₁-C₁₀alkyl-acrylate.

According to another example, the post-functionalization reaction may be selected from an esterification reaction and an amidation reaction. For example, the post-functionalization reaction may be a Fisher esterification, a Steglich esterification, or a reaction as described in U.S. Pat. No. 7,897,674 B2 (Zaghib et al.). According to another example, an ionic polymer having a carbamate functional group can be obtained by the reaction between 2-isocyanatoethyl methacrylate with a functional group of the ionic polymer. According to another example, an ionic polymer having an acrylate functional group may be obtained by the reaction between a functional group of the ionic polymer with an acrylic acid (CH₂═CHCOOH), a methacrylic acid (CH₂C(CH₃)COOH), an acryloyl chloride (CH₂═CHCO(Cl)), a methacryloyl chloride (CH₂═C(CH₃)CO(Cl)), or another compatible carboxylic acid derivative.

According to another example, the process further comprises a step of substituting at least one halogen atom, for example, a chlorine atom. For example, the substitution step may be carried out by a nucleophilic substitution reaction of halogen atoms with a nucleophilic reagent. According to one example, the nucleophilic reagent may be a salt, for example, a lithium salt such as lithium bis(trifluoromethanesulfonyl)imide (LiTFSI) or a silver salt such as silver tetrafluoroborate (AgBF₄). According to one variant of interest, the substitution step may be carried out by the nucleophilic substitution of at least one chlorine atom with an anion (for example, TFSI or BF₄). According to one example, the ionic polymer is brought into contact to react with at least one nucleophilic reagent. For example, the ionic polymer can be contacted with a sufficient amount of the nucleophilic reagent at a sufficiently high temperature and for a sufficient amount of time to ensure a substantially complete nucleophilic substitution reaction. For example, the ionic polymer can be contacted with about 10 wt. % LiTFSI at a temperature of about 40° C. for about 2 hours to ensure a substantially complete nucleophilic substitution reaction. For example, the nucleophilic reagent can then be removed by filtration and precipitation in a suitable solvent, for example, ethyl acetate or methanol.

According to another example, the process further comprises a separation or purification step. The separation or purification step may be carried out by any known compatible separation or purification methods. For example, the separation or purification step may be carried out by a separation method based on molecular weight. The separation or purification step may be carried out by a liquid chromatography method (for example, steric exclusion chromatography) or a filtration method (for example, a membrane filtration or separation method). For example, the separation or purification step is carried out by a membrane filtration method (for example, nanofiltration or ultrafiltration). In some embodiments, the separation or purification step can be carried out by ultrafiltration. For example, the ultrafiltration can be carried out with a membrane having a molecular weight cut off (MWCO) limit of 1,000 DA (daltons) (or 1.66×10⁻¹⁵ μg), in order to separate low molecular weight impurities (for example, less than 1000 DA) from the ionic polymer. According to another example, the separation or purification step can be carried out before and/or after the post-functionalization or post-polymerization modification step.

According to another example, the process further comprises a step of coating (also called spreading) the polymer composition or a suspension comprising the ionic polymer as described above. For example, said coating step may be carried out by at least one of a doctor blade coating method, a comma coating method, a reverse comma coating method, a printing method such as gravure coating, or a slot-die coating method. According to one variant of interest, said coating step is carried out by a doctor blade coating method or a slot-die coating method. According to one example, the polymer composition or suspension comprising the ionic polymer may be coated on a substrate or support film (for example, a substrate made of silicone, polypropylene, or siliconized polypropylene). For example, said substrate or support film may be subsequently removed. According to another example, the polymer composition or suspension comprising the ionic polymer may be coated directly on an electrode.

According to another example, the process further comprises a step of drying the polymer composition or ionic polymer as defined above. According to one example, the drying step may be carried out in order to remove any residual solvent. According to another example, the drying step and the coating step may be carried out simultaneously and/or separately.

According to another example, the process further comprises a step of crosslinking the polymer composition or the ionic polymer as defined above. For example, at least one terminal group or substituent on the carbon chain of the ionic polymer (for example, R₁ and/or R₂) comprises at least one functional group enabling crosslinking of the ionic polymer. According to another example, the crosslinking step can be carried out by UV irradiation, by heat treatment, by microwave irradiation, under an electron beam, by gamma irradiation or by X-ray irradiation. According to one variant of interest, the crosslinking step is carried out by UV irradiation. According to another variant of interest, the crosslinking step is carried out by heat treatment. According to another variant of interest, the crosslinking step is carried out under an electron beam. According to another example, the crosslinking step may be carried out in the presence of a crosslinking agent, a thermal initiator, a photoinitiator, a catalyst, a plasticizing agent, or a combination of at least two thereof. For example, the photoinitiator is 2,2-dimethoxy-2-phenylacetophenone (Irgacure™ 651). For example, the polymer composition and the ionic polymer can solidify after crosslinking.

The present technology also relates to the use of a polymer composition or ionic polymer as defined above in electrochemical applications.

According to one example, the polymer composition or ionic polymer may be used in electrochemical cells, batteries, supercapacitors (for example, carbon-carbon supercapacitor, hybrid supercapacitors, etc.). According to another example, the polymer composition or ionic polymer can be used in electrochromic materials, electrochromic cells, electrochromic devices (ECDs), and electrochromic sensors such as those described in U.S. Pat. No. 5,356,553.

According to another example, the polymer composition as herein defined may be a solid polymer electrolyte composition. According to another example, the polymer composition as herein defined may be used as a component of an electrode material, for example, as a binder in an electrode material.

The present technology thus also relates to a solid polymer electrolyte comprising an ionic polymer as defined above or a polymer composition as defined above (i.e., comprising an ionic polymer as defined above), where the ionic polymer may optionally be crosslinked if crosslinkable functional groups are present therein.

According to one example, the solid polymer electrolyte composition or the solid polymer electrolyte as defined above may further comprise at least one salt. For example, the salt may be dissolved in the solid polymer electrolyte composition or in the solid polymer electrolyte.

The salt may be an ionic salt such as a lithium, sodium, potassium, calcium, or magnesium salt. According to one variant of interest, the ionic salt is a lithium salt. Non-limiting examples of lithium salts include lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyanoimidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCl), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiTf), lithium fluoroalkylphosphate Li[PF₃(CF₂CF₃)₃] (LiFAP), lithium tetrakis(trifluoroacetoxy)borate Li[B(OCOCF₃)₄] (LiTFAB), lithium bis(1,2-benzenediolato(2-)-O,O′)borate Li[B(C₆O₂)₂] (LiBBB), and a combination of at least two thereof. According to one variant of interest, the lithium salt may be LiPF₆. According to another variant of interest, the lithium salt may be LiFSI. According to another variant of interest, the lithium salt may be LiTFSI. Non-limiting examples of sodium salts include the salts described above where the lithium ion is replaced by a sodium ion. Non-limiting examples of potassium salts include the salts described above where the lithium ion is replaced by a potassium ion. Non-limiting examples of calcium salts include the salts described above where the lithium ion is replaced by a calcium ion and where the number of anions present in the salt is adjusted to the charge of the calcium ion. Non-limiting examples of magnesium salts include the salts described above where the lithium ion is replaced by a magnesium ion and where the number of anions present in the salt is adjusted to the charge of the magnesium ion.

According to another example, the solid polymer electrolyte composition or solid polymer electrolyte as defined above may further optionally include additional components or additives such as ionically conductive materials, inorganic particles, glass particles, ceramic particles (for example, nanoceramics), other similar additives, or a combination of at least two thereof. For example, the additional component or additive may be selected for its high ionic conductivity and may, in particular, be added in order to improve conduction of lithium ions. According to one variant of interest, the additional component or additive may be selected from NASICON, LISICON, thio-LiSICON, garnets, in crystalline and/or amorphous form, and a combination of at least two thereof.

According to another example, the solid polymer electrolyte may be in the form of a thin film. For example, the film comprises at least one electrolytic layer including the solid polymer electrolyte. In some cases, the additional components or additives defined above may be included and/or substantially dispersed in the electrolytic layer or separately in an ion-conducting layer, for example, deposited on the electrolytic layer.

The present technology also relates to an electrode material comprising at least one electrochemically active material and an ionic polymer as defined above or a polymer composition as defined herein (i.e., comprising an ionic polymer as defined herein). According to one example, the ionic polymer acts as a binder in the electrode material. According to one example, the electrode material is a positive electrode material. According to another example, the electrode material is a negative electrode material.

According to an example, the electrochemically active material may be in the form of particles. Non-limiting examples of electrochemically active materials include metal oxides, lithium metal oxides, metal phosphates, lithium metal phosphates, titanates, and lithium titanates.

For example, the metal of the electrochemically active material may be selected from the elements: titanium (Ti), iron (Fe), magnesium (Mg), manganese (Mn), vanadium (V), nickel (Ni), cobalt (Co), aluminum (Al), chromium (Cr), copper (Cu), antimony (Sb), and a combination of at least two thereof, when compatible. According to one variant of interest, the metal of the electrochemically active material may be selected from titanium (Ti), iron (Fe), magnesium (Mg), manganese (Mn), vanadium (V), nickel (Ni), cobalt (Co), aluminum (Al), and a combination of at least two thereof, when compatible.

Non-limiting examples of electrochemically active materials also include titanates and lithium titanates (for example, TiO₂, Li₂TiO₃, Li₄Ti₅O₁₂, H₂Ti₅O₁₁, H₂Ti₄O₉, and a combination thereof), metal phosphates and lithiated metal phosphates (for example, LiM′PO₄ and M′PO₄, where M′ may be Fe, Ni, Mn, Mg, Co, and a combination thereof), vanadium oxides and lithium vanadium oxides (for example, LiV₃O₈, V₂O₅, LiV₂O₅ and the like), and other lithium metal oxides of formulae LiMn₂O₄, LiM″O₂ (where M″ is selected from Mn, Co, Ni and a combination thereof), Li(NiM′″)O₂ (where M′″ is selected from Mn, Co, Al, Fe, Cr, Ti, Zr, another similar metal, and a combination thereof), and a combination of at least two thereof, when compatible.

According to another example, the electrochemically active material may optionally be doped with other elements or impurities, which may be included in smaller amounts, for example, to modulate or optimize its electrochemical properties. For example, the electrochemically active material may be doped by the partial substitution of the metal with other ions. For example, the electrochemically active material may be doped with a transition metal (for example, Ti, V, Cr, Mn, Fe, Co, Ni, Cu, Zn, or Y) and/or a metal other than a transition metal (for example, Mg, Al, or Sb).

According to another example, the electrochemically active material may be in the form of particles (for example, microparticles and/or nanoparticles) which may be freshly formed or commercially sourced and may further comprise a coating material. The coating material may be an electronically conductive material, for example, the coating may be a carbon coating.

According to another example, the electrode material is a negative electrode material comprising, for example, a carbon-coated lithium titanate (c-LTO) as an electrochemically active material.

According to another example, the electrode material may also optionally comprise additional components or additives such as ionic conductors, inorganic particles, glass or ceramic particles, nanoceramics (for example, Al₂O₃, TiO₂, SiO₂ and other similar compounds), salts (for example, lithium salts), and other similar additives. For example, the additional component or additive may be an ionic conductor selected from NASICON, LISICON, thio-LiSICON, garnet, sulfide, sulfur halide, phosphate, and thio-phosphate compounds, in crystalline and/or amorphous form, and a combination of at least two thereof.

According to another example, the electrode material as herein defined may further comprise an electronically conductive material. Non-limiting examples of electronically conductive materials include carbon black (for example, Ketjen™ carbon and Super P™ carbon), acetylene black (for example, Shawinigan carbon and Denka™ carbon black), graphite, graphene, carbon fibers (for example, vapor grown carbon fibers (VGCFs)), carbon nanofibers, carbon nanotubes (CNTs), and a combination of at least two thereof.

The present technology also relates to an electrode comprising the electrode material as defined herein on a current collector (for example, aluminum or copper). Alternatively, the electrode may be a self-supported electrode. According to one variant of interest, the electrode as herein defined is a positive electrode. According to another variant of interest, the electrode as herein defined is a negative electrode.

The present technology also relates to an electrochemical cell comprising a negative electrode, a positive electrode and an electrolyte, wherein at least one of the negative electrode, the positive electrode and the electrolyte comprises the ionic polymer as herein defined or the polymer composition as herein defined.

The present technology also relates to an electrochemical cell comprising a negative electrode, a positive electrode and an electrolyte, wherein at least one of the negative electrode, the positive electrode and the electrolyte is as herein defined. According to one embodiment of interest, the electrolyte is a solid polymer electrolyte as herein defined. According to another embodiment of interest, the negative electrode is as herein defined. According to another variant of interest, the positive electrode is as herein defined. According to a variant of interest, the electrolyte is a solid polymer electrolyte as herein defined and the positive electrode is as herein defined.

The present technology also relates to a battery comprising at least one electrochemical cell as defined herein. For example, said battery may be selected from a lithium battery, a lithium-ion battery, a lithium-sulfur battery, a sodium battery, a sodium-ion battery, a magnesium battery, and a magnesium-ion battery. According to one variant of interest, the battery is a lithium battery or a lithium-ion battery. For example, the battery may be an all-solid-state battery (for example, an all-solid-state lithium battery).

### EXAMPLES

The following examples are for illustrative purposes and should not be construed as further limiting the scope of the invention as contemplated. These examples will be better understood by referring to the accompanying figures.

### Example 1—Synthesis of a bis(chlorosulfonyl)imide (Cl—SO₂—NH—SO₂—Cl)

The synthesis of the bis(chlorosulfonyl)imide was carried out by the reaction between sulfamic acid and thionyl chloride, then, by reacting the product thus obtained with chlorosulfonic acid. Bis(chlorosulfonyl)imide was therefore prepared by a process as illustrated in Scheme 5:

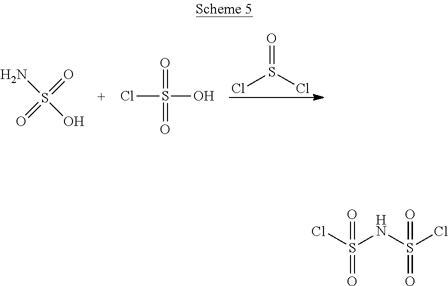

1.0 equivalent of sulfamic acid was placed in a clean and dry flask fitted with a magnetic bar and suspended in an excess volume of thionyl chloride (2.75 equivalents). All manipulations were carried out under a constant flow of nitrogen. 1.0 equivalent of chlorosulfonic acid was added dropwise and the flask was equipped with a vapor trap including a saturated sodium hydroxide or lithium hydroxide aqueous solution for neutralizing hydrochloric acid vapors. Then, the mixture thus obtained was heated on a sand bath at a temperature of about 130° C. under constant stirring for about 24 hours.

The mixture was then purified by vacuum distillation at a temperature of about 180° C., a heat gun was used to heat the mixture. The distillation was carried out without water circulation in the refrigerant and with a cold trap filled with liquid nitrogen. The temperature was increased at the end of the distillation to ensure that it was complete. The distillation was stopped before smoke formation to avoid contamination of the product.

The product thus obtained was then cooled to form bis(chlorosulfonyl)imide crystals and stored in a freezer.

### Example 2—Synthesis of Lithium bis(chlorosulfonyl)imide

The lithium bis(chlorosulfonyl)imide was prepared by a process as illustrated in Scheme 6:

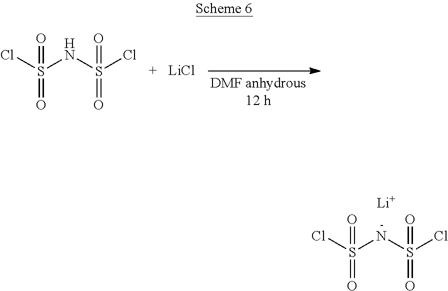

The synthesis of lithium bis(chlorosulfonyl)imide was carried out in a glove box under an inert nitrogen atmosphere. 1.0 equivalent of bis(chlorosulfonyl)imide prepared in Example 1 was weighed and introduced in a flask which was previously cleaned and dried at a temperature of 120° C. for 2 hours to remove any residual water. The flask was then closed with a septum. Between about 1.0 and about 1.5 equivalents of lithium chloride dissolved in anhydrous N,N-dimethylformamide was added to the flask using a needle through the septum.

The flask was then removed from the glove box and placed under a constant flow of nitrogen at a temperature of about 100° C. for about 24 hours in order to ensure complete lithiation of the mixture and activation of the lithium bis(chlorosulfonyl)imide by the N,N-dimethylformamide.

### Example 3—Polymerization

### (a) Polymerization of Diethylene Glycol with the Lithium bis(chlorosulfonyl)imide Prepared in Example 2 (Polymer 1)

The polymerization was carried out by a catalyst-controlled polycondensation of diethylene glycol with the lithium bis(chlorosulfonyl)imide prepared in Example 2. The polymerization was thus controlled with a polycondensation catalyst.

The mixture comprising the lithium bis(chlorosulfonyl)imide prepared in Example 2 was cooled in an ice bath for 20 minutes. The septum was then removed, and the neck of the flask was then washed with solvent to recover as much product as possible. The flask was then closed with a new septum.

3 equivalents of triethylamine were then added to the mixture. Subsequently, 25 mg of trifluorophenyl boronic acid and 400 mg of 4-dimethylaminopyridine were added to the mixture. 1 equivalent of diethylene glycol was then added, and the reaction mixture was heated at a temperature of about 100° C. for about 72 hours.

The reaction mixture was then cooled, filtered, and precipitated in ethyl acetate. The reaction mixture was placed in an ice bath for about 30 minutes and then decanted.

The resulting polymer was then dissolved in a solvent mixture comprising isopropanol and acetone (2:8 volume ratio) and placed in a freezer for about 1 hour. The mixture was then filtered to remove residual triethylamine chloride. The solvent was then evaporated using a rotary evaporator at a temperature of about 60° C. Finally, the polymer was dried in a vacuum oven at a temperature of about 60° C.

The Polymer 1 thus obtained was then dissolved in 400 mL of water and filtered for about 7 hours by ultrafiltration with a membrane having a molecular weight cut off limit of 1,000 DA.

The substitution of chlorine atoms was carried out by a nucleophilic substitution reaction using silver tetrafluoroborate as the nucleophilic reagent. The determination of chloride ions present in Polymer 1 was performed by Mohr's method to calculate the required amount of silver tetrafluoroborate. The required amount of silver tetrafluoroborate was then dissolved in a minimum amount of water and added to a solution comprising 1 g of Polymer 1 dissolved in 20 mL of water. The solution was then stirred for about 15 minutes at room temperature and then filtered and washed with methanol. The filtrate thus obtained was then evaporated to dryness. The substitution was confirmed by fluorine nuclear magnetic resonance (fluorine-19 NMR).

### (b) Post-Functionalization of the Polymer Prepared in Example 3(a) (Polymer 2)

Polymer 2 was prepared by post-functionalization of Polymer 1 presented in Example 3(a) in order to introduce crosslinkable groups.

4 g of the polymer prepared in Example 3(a) were dissolved in 25 ml of anhydrous N,N-dimethylformamide. 1 ml of 2-isocyanatoethyl acrylate was then added to the solution, and the resulting mixture was heated under a nitrogen atmosphere at a temperature of about 50° C. for about 5 to 12 hours. 5 ml of methanol were then added to the solution and the solution was cooled to room temperature.

The polymer thus obtained (Polymer 2) was then dissolved in 400 mL of water and filtered for about 7 hours by ultrafiltration with a membrane having a molecular weight cut off limit of 1,000 DA.

Polymer 2 was analyzed by steric exclusion chromatography (SEC), by proton nuclear magnetic resonance (proton NMR), by Fourier transform infrared spectroscopy (FTIR), and by differential scanning calorimetry (DSC).

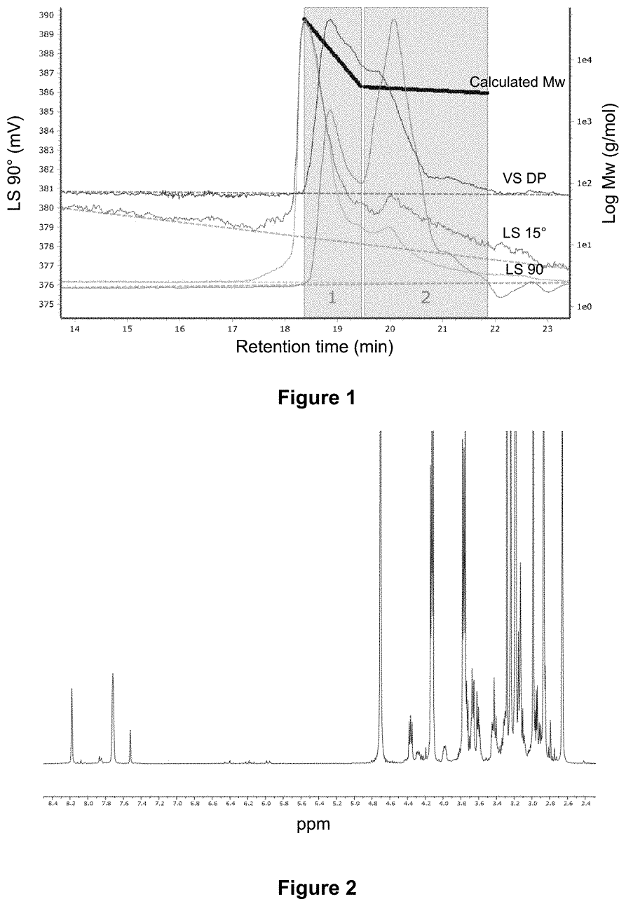

FIG. 1 shows the results of the steric exclusion chromatography analysis obtained for Polymer 2. The results were obtained to determine the average molecular weight of Polymer 2 (g/mol). The steric exclusion chromatography was performed with a refractive index (RI) detector and at a flow rate of 0.90 ml·min⁻¹. The steric exclusion chromatography results obtained with Polymer 2 are presented in Tables 1 and 2.

TABLE 1
Peak results

| | Peak 1 | Peak 2 |
|---|---|---|
| Detector | Refractive index | Refractive index |
| Retention time (RT) (min) | 18.86667 | 20.08333 |
| Molar mass (Mw) (g/mol) | 1 6618 | 5026 |
| Intrinsic viscosity (IV) (dL/g) | 0.089790 | 0.035070 |
| Peak height (mV) | 9.901 | 14.988 |
| Peak height (%) | 39.78 | 60.22 |
| Peak area (mV · s) | 389.477 | 810.563 |
| Area (%) | 32.46 | 67.54 |
| Concentration (mg/mL) | 2.470 | 5.140 |

| | |
|---|---|
| Recovery (%) | 100 |

TABLE 2
Molecular weight averages

| | Peak 1 | Peak 2 |
|---|---|---|
| Mp (g/mol) | 1 5051 | 3 462 |
| Mn (g/mol) | 9 202 | 3 418 |
| Mw (g/mol) | 1 2542 | 3 424 |
| Mz (g/mol) | 1 6300 | 3 430 |
| Mz + 1 (g/mol) | 1 9776 | 3 435 |
| Mv (g/mol) | 1 4688 | 3 429 |
| PD | 1.363 | 1.002 |

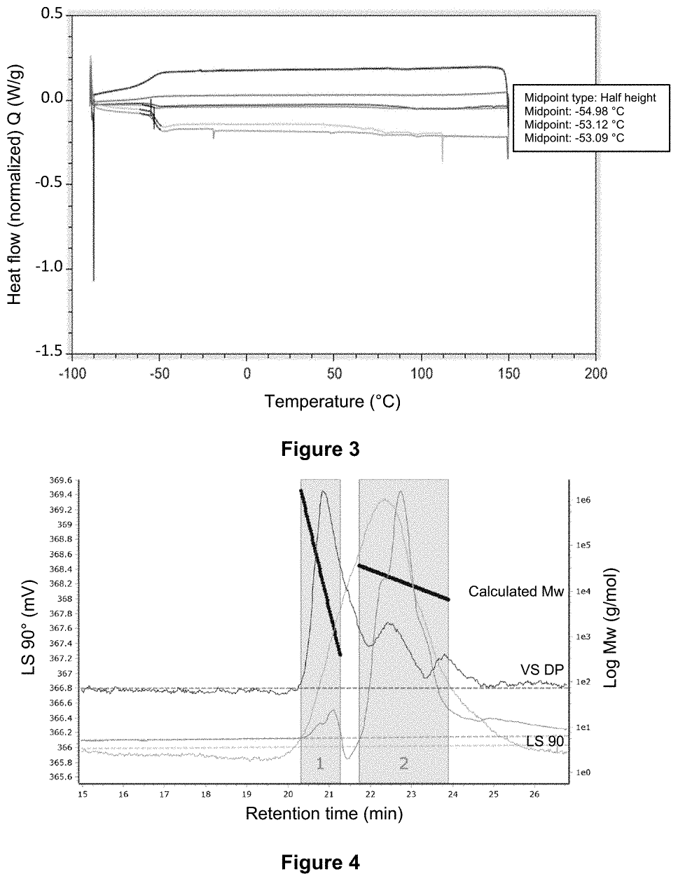

FIG. 2 presents a proton NMR spectrum obtained for Polymer 2. FIG. 3 shows the results of differential scanning calorimetry analysis obtained for Polymer 2. As shown in FIG. 3, Polymer 2 has a glass transition temperature (T_{g})=−53° C.

The lithium concentration of Polymer 2 was then determined. 30% by weight of a modified ion exchange resin marketed under the brand name DOWEX® was then added to the solution. The suspension thus obtained was then stirred for a period of about 12 hours at room temperature and then filtered. The filtrate thus obtained was evaporated to dryness and dried in a vacuum oven at a temperature of about 65° C. for about 24 hours. The lithium concentration in the polymer was determined by lithium nuclear magnetic resonance (⁷Li NMR) relative to a standard solution of lithium chloride.

Said modified ion exchange resin was obtained by the following method: A glass column was filled with 30 g of Dowex® 50WX8 (H⁺) resin and wetted with a 2 M lithium hydroxide aqueous solution. The resin was rinsed until a basic pH was reached at the end of the column. Subsequently, the resin thus modified was washed with ultrapure water until a neutral pH was obtained and then washed with 300 ml of methanol. The resin was then oven dried at a temperature of about 60° C. for about 12 hours. Alternatively, the modified ion exchange resin can be prepared by stirring 30 g of Dowex® 50WX8 (H⁺) resin in 300 ml of a 2 M lithium hydroxide aqueous solution for about 12 hours and then filtering the suspension thus obtained. The resin thus modified is then washed and dried as described above.

### (c) Polymerization of 2,2,3,3,4,4,5,5-octafluoro-1,6-hexanediol with the Lithium bis(chlorosulfonyl)imide Prepared in Example 2 (Polymer 3)

The polymerization was carried out by a catalyst-controlled polycondensation of 2,2,3,3,4,4,5,5-octafluoro-1,6-hexanediol with the lithium bis(chlorosulfonyl)imide prepared in Example 2.

The mixture comprising the lithium bis(chlorosulfonyl)imide of Example 2 was cooled in an ice bath for 20 minutes. The septum was then removed, and the neck of the flask was then washed with solvent to recover as much product as possible. The flask was then closed with a new septum.

3 equivalents of triethylamine were then added to the mixture. Subsequently, 25 mg of trifluorophenyl boronic acid and 400 mg of 4-dimethylaminopyridine were added to the mixture. 1 equivalent of 2,2,3,3,4,4,5,5-octafluoro-1,6-hexanediol was then added, and the reaction mixture was heated at a temperature of about 100° C. for about 72 hours.

The reaction mixture was then cooled, filtered, and precipitated in ethyl acetate. The reaction mixture was placed in an ice bath for about 30 minutes and then decanted.

The polymer was then dissolved in a solvent mixture comprising isopropanol and acetone (2:8 volume ratio) and placed in a freezer for about 1 hour. The mixture was then filtered in order to remove residual triethylamine chloride. The solvent was then evaporated using a rotary evaporator at a temperature of about 60° C. Finally, the polymer was dried in a vacuum oven at a temperature of about 60° C.

The polymer thus obtained (Polymer 3) was then dissolved in 400 ml of water and filtered for about 7 hours by ultrafiltration with a membrane having a molecular weight cut off limit of 1,000 DA.

The substitution of chlorine atoms was then carried out by the method described in Example 3(a).

### (d) Post-Functionalization of the Polymer Prepared in Example 3 (c) (Polymer 4)

Polymer 4 was prepared by post-functionalization of Polymer 3 presented in Example 3(c) in order to introduce crosslinkable groups.

4 g of the polymer prepared in Example 3(c) were dissolved in 25 ml of anhydrous N,N-dimethylformamide. 1 ml of 2-isocyanatoethyl methacrylate was then added to the solution and the mixture thus obtained was then heated under a nitrogen atmosphere at a temperature of about 50° C. for about 5 to 12 hours.

The polymer thus obtained (Polymer 4) was then dissolved in 400 ml of water and filtered for about 7 hours by ultrafiltration with a membrane having a molecular weight cut off limit of 1,000 DA.

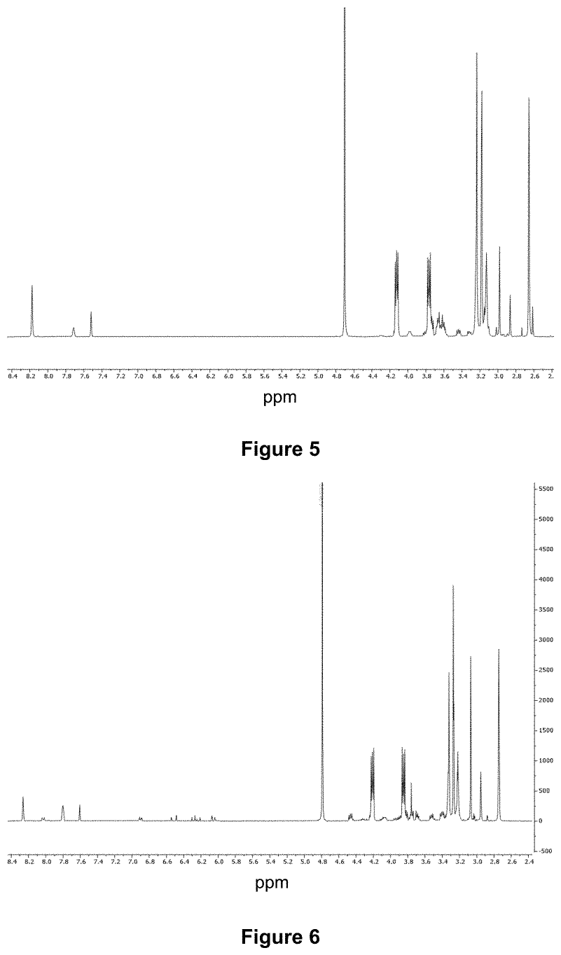

Polymer 4 was analyzed by steric exclusion chromatography and the results are shown in FIG. 4. The steric exclusion chromatography was performed with a refractive index detector and at a flow rate of 0.80 ml·min⁻¹. The steric exclusion chromatography results obtained with Polymer 4 are also presented in Tables 3 and 4.

TABLE 3
Peak results

| | Peak 1 | Peak 2 |
|---|---|---|
| Detector | Refractive index | Refractive index |
| Retention time (RT) (min) | 21.08333 | 22.73333 |
| Molar mass (Mw) (g/mol) | 38 018 | 16 881 |
| Intrinsic viscosity (IV) (dL/g) | 0.264825 | 0.009352 |
| Peak height (mV) | 0.866 | 7.619 |
| Peak height (%) | 10.20 | 89.80 |
| Peak area (mV · s) | 23.608 | 479.553 |
| Area (%) | 4.69 | 95.31 |
| Concentration (mg/mL) | 0.235 | 4.765 |

| | |
|---|---|
| Recovery (%) | 100 |

TABLE 4
Molecular weight averages

| | Peak 1 | Peak 2 |
|---|---|---|
| Mp (g/mol) | 1 936 | 16 311 |
| Mn (g/mol) | 2 393 | 14 886 |
| Mw (g/mol) | 39 026 | 16 879 |
| Mz (g/mol) | 40 6139 | 18 847 |
| Mz + 1 (g/mol) | 88 8519 | 20 673 |
| Mv (g/mol) | 19 3778 | 1 9011 |
| PD | 16.31 | 1.134 |

The lithium concentration of Polymer 4 was also determined by the method described in Example 3(b).

### (e) Polymerization of Glycerol and Diethylene Glycol with the Lithium bis(chlorosulfonyl)imide Prepared in Example 2 (Polymer 5)

The polymerization was carried out by a catalyst-controlled polycondensation of glycerol and diethylene glycol with the lithium bis(chlorosulfonyl)imide prepared in Example 2.

The mixture comprising the lithium bis(chlorosulfonyl)imide of Example 2 was cooled in an ice bath for 20 minutes. The septum was then removed, and the neck of the flask was then washed with solvent to recover as much product as possible. The flask was then closed with a new septum.

3 equivalents of triethylamine were then added to the mixture. Subsequently, 25 mg of trifluorophenyl boronic acid and 400 mg of 4-dimethylaminopyridine were added to the mixture. 0.90 equivalent of diethylene glycol and 0.10 equivalent of glycerol were then added, and the reaction mixture was heated to a temperature of about 100° C. for about 72 hours.

The reaction mixture was then cooled, filtered, and precipitated in ethyl acetate. The reaction mixture was placed in an ice bath for about 30 minutes and subsequently decanted.

The polymer was then dissolved in a solvent mixture comprising isopropanol and acetone (2:8 volume ratio) and placed in a freezer for about 1 hour. The mixture was then filtered in order to remove residual triethylamine chloride. The solvent was then evaporated using a rotary evaporator at a temperature of about 60° C. Finally, the polymer was dried under vacuum in an oven at a temperature of about 60° C.

The polymer thus obtained (Polymer 5) was then dissolved in 400 ml of water and filtered for about 7 hours by ultrafiltration with a membrane having a molecular weight cut off limit of 1,000 DA.

The substitution of chlorine atoms was then performed by the method described in Example 3(a).

Polymer 5 was analyzed by proton nuclear magnetic resonance (1H NMR), by carbon-13 nuclear magnetic resonance (13C NMR), by fluorine nuclear magnetic resonance (19F NMR), and by differential scanning calorimetry (DSC).

FIG. 5 shows a proton NMR spectrum obtained for a polymer obtained by the polymerization of diethylene glycol with the lithium bis(chlorosulfonyl)imide prepared in Example 2, for example, by the method as described in Example 3(a).

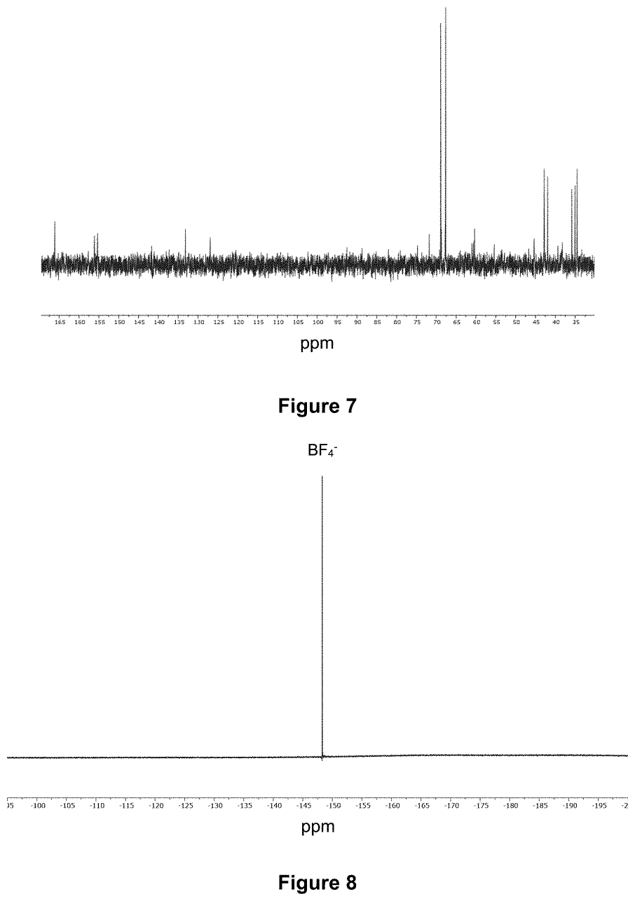

FIGS. 6 to 8 present the proton NMR spectrum, the carbon-13 NMR spectrum, and fluorine NMR spectrum obtained for Polymer 5, respectively.

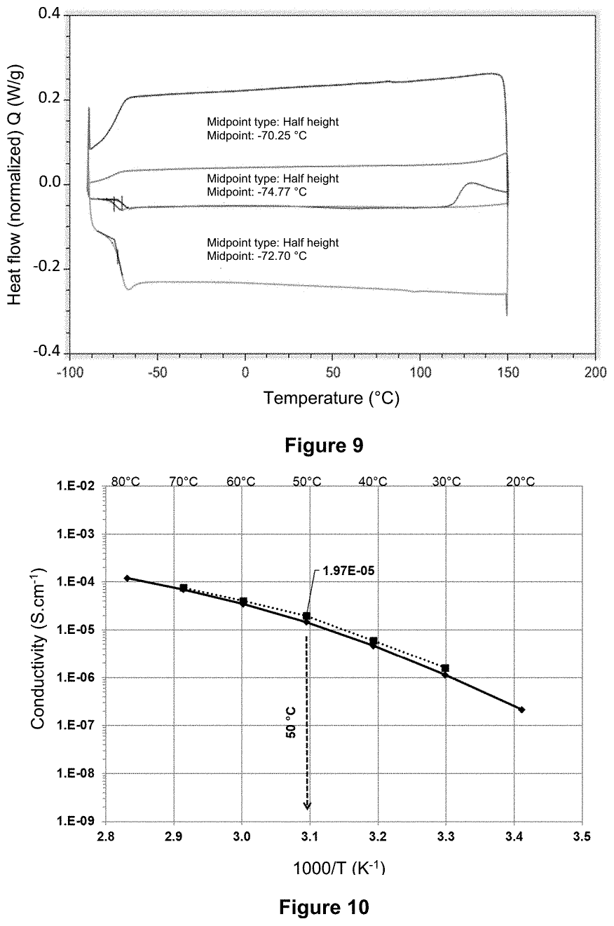

FIG. 9 presents the results of the differential scanning calorimetry analysis obtained for Polymer 5 and demonstrates that Polymer 5 has a glass transition temperature (T_{g})=−73° C.

### (f) Post-Functionalization of the Polymer Prepared in Example 3(e) (Polymer 6)

Polymer 6 was prepared by post-functionalization of Polymer 5 presented in Example 3(e) in order to introduce crosslinkable groups.

4 g of the polymer prepared in Example 3(e) were dissolved in 25 ml of anhydrous N,N-dimethylformamide. 1 mL of 2-isocyanatoethyl methacrylate was then added to the solution and the mixture thus obtained was heated under a nitrogen atmosphere at a temperature of about 50° C. for about 5 to 12 hours.

The polymer thus obtained (Polymer 6) was then dissolved in 400 ml of water and filtered for about 7 hours by ultrafiltration with a membrane having a molecular weight cut off limit of 1,000 DA.

The lithium concentration of Polymer 6 was also determined by the method described in Example 3(b). A lithium concentration of 25 mol. % was obtained for Polymer 6.

### Example 4—Ionic Conductivity

Examples 4(a) to 4(d) relate to the preparation of polymer films for measuring the ionic conductivity of the polymers as defined herein by the method as described in the present application, while Examples 4(e) and 4(f) are for comparison purposes.

### a) Preparation of Polymer Film Comprising Polymer 1

The ionic conductivity results were obtained for Polymer 1 prepared in Example 3(a). 1.7 g of the polymer prepared in Example 3(a) was solubilized in 1.4 g of a solvent mixture comprising water and methanol (80:20 by volume) and without the addition of additional lithium salt. 10% by weight polyvinylidene fluoride (PVdF) was added to the suspension thus obtained.

The suspension was then applied to a substrate or support film using a hot plate coating system (Erichsen testing instruments) with a 3-mil slit opening at a speed of 15 mm·s⁻¹. The polymer film thus obtained was dried at a temperature of 70° C. directly during coating.

The polymer film was then vacuum dried in an oven at a temperature of 85° C. for 48 hours to remove residual solvent.

The polymer film was then removed from the surface of the substrate or support film.

### b) Preparation of the Polymer Film Comprising Polymer 2

The ionic conductivity results were obtained for Polymer 2 prepared in Example 3(b). 1.7 g of the polymer prepared in Example 3(b) was solubilized in 1.4 g of a solvent mixture comprising water and methanol (80:20 by volume) and without adding any additional lithium salt.

The suspension thus obtained was then applied to a substrate or support film using a hot plate coating system (Erichsen testing instruments) with a 3-mil slit opening and at a speed of 15 mm·s⁻¹. The polymer film thus obtained was dried at a temperature of 70° C. directly during coating.

The polymer film was then vacuum dried in an oven at a temperature of 85° C. for 48 hours to remove residual solvent.

After drying, the polymer film was placed in a polycarbonate (lexan) box under an inert helium atmosphere to reduce the presence of oxygen and moisture. The polymer film was then irradiated for 5 minutes with UV light (wavelength of 254 nm) placed at a distance of about 5 cm from the polymer film.

The polymer film was then removed from the surface of the substrate or support film.

### c) Preparation of the Polymer Film Comprising Polymer 4

The ionic conductivity results were obtained for Polymer 4 prepared in Example 3(d). 1.7 g of the polymer prepared in Example 3(d) was solubilized in 1.4 g of a solvent mixture comprising water and methanol (80:20 by volume) and without adding any additional lithium salt.

The suspension thus obtained was then applied to a substrate or support film using a hot plate coating system (Erichsen testing instruments) with a 3-mil slit opening and at a speed of 15 mm·s⁻¹. The polymer film thus obtained was dried at a temperature of 70° C. directly during coating.

The polymer film was then vacuum dried in an oven at a temperature of 85° C. for 48 hours to remove residual solvent.

After drying, the polymer film was placed in a polycarbonate (lexan) box under an inert helium atmosphere to reduce the presence of oxygen and moisture. The polymer film was then irradiated for 5 minutes with UV light (wavelength of 254 nm) placed at a distance of about 5 cm from the polymer film.

The polymer film was then removed from the surface of the substrate or support film.

### d) Preparation of the Polymer Film Comprising Polymer 6

The ionic conductivity results were obtained for the Polymer 6 prepared in Example 3(f). 1.7 g of the polymer prepared in Example 3(f) was solubilized in 1.4 g of a solvent mixture comprising water and methanol (80:20 by volume) and without adding any additional lithium salt.

The suspension thus obtained was then applied to a substrate or support film using a hot plate coating system (Erichsen testing instruments) with a 3-mil slit opening and at a speed of 15 mm·s⁻¹. The polymer film thus obtained was dried at a temperature of 70° C. directly during coating.

The polymer film was then vacuum dried in an oven at a temperature of 85° C. for 48 hours to remove residual solvent.

After drying, the polymer film was placed in a polycarbonate (lexan) box under an inert helium atmosphere to reduce the presence of oxygen and moisture. The polymer film was then irradiated for 5 minutes with UV light (wavelength of 254 nm) placed at a distance of about 5 cm from the polymer film.

The polymer film was then removed from the surface of the substrate or support film.

### e) Preparation of Polymer Film Comprising Polymer 7 (Comparative)

The ionic conductivity results were obtained for a polymer as described in U.S. Pat. No. 7,897,674 B2 (Zaghib et al.) (US′674). 1.7 g of the polymer was solubilized in 1.4 g of a solvent mixture comprising water and methanol (80:20 by volume) and without adding any additional lithium salt.

The suspension thus obtained was then applied to a substrate or support film using a hot plate coating system (Erichsen testing instruments) with a 3-mil slit opening and at a speed of 15 mm·s⁻¹. The polymer film thus obtained was dried at a temperature of 70° C. directly during coating.

The polymer film was then vacuum dried in an oven at a temperature of 85° C. for 48 hours to remove residual solvent.

After drying, the polymer film was placed in a polycarbonate (lexan) box under an inert helium atmosphere to reduce the presence of oxygen and moisture. The polymer film was then irradiated for 5 minutes with UV light (wavelength of 254 nm) placed at a distance of about 5 cm from the polymer film.

The polymer film was then removed from the surface of the substrate or support film.

### f) Preparation of Polymer Film Comprising Polymer 8 (Comparative)

The ionic conductivity results were obtained for a polymer as described in U.S. Pat. No. 6,903,174 B2 (Harvey et al.) (US′174). 1.7 g of the polymer was solubilized in 1.4 g of a solvent mixture comprising water and methanol (80:20 by volume) and without adding any additional lithium salt. 0.5 wt. % of 2,2-dimethoxy-2-phenylacetophenone (Irgacure™ 651) was added to the suspension thus obtained.

The suspension thus obtained was then applied to a substrate or support film using a hot plate coating system (Erichsen testing instruments) with a 3-mil slit opening and at a speed of 15 mm·s⁻¹. The polymer film thus obtained was dried at a temperature of 70° C. directly during coating.

The polymer film was then vacuum dried in an oven at a temperature of 85° C. for 48 hours to remove residual solvent.

After drying, the polymer film was placed in a polycarbonate (lexan) box under an inert helium atmosphere to reduce the presence of oxygen and moisture. The polymer film was then irradiated for 5 minutes with UV light (wavelength of 254 nm) placed at a distance of about 5 cm from the polymer film.

The polymer film was then removed from the surface of the substrate or support film.

g) Preparation of Symmetric Cells for Ionic Conductivity Measurements

Preparation of symmetrical cells comprising the polymer films prepared in Examples 4(a) to 4(f) was entirely carried out in an anhydrous chamber with a dew point of about −55° C. Assembly of the symmetric cells was performed in a button cell configuration. The polymer films were placed between two stainless steel blocking electrodes with an active area of 2.01 cm². The symmetric cells were assembled in the configurations indicated in Table 5.

TABLE 5
Symmetrical cell configurations

| Symmetric cell | Polymer film | Polymer |
|---|---|---|
| Cell 1 | Prepared in Example 4 (a) | Polymer 1 |
| Cell 2 | Prepared in Example 4 (b) | Polymer 2 |
| Cell 3 | Prepared in Example 4 (c) | Polymer 4 |
| Cell 4 | Prepared in Example 4 (d) | Polymer 6 |
| Cell 5 (comparative cell) | Prepared in Example 4 (e) | Polymer 7 |
| Cell 6 (comparative cell) | Prepared in Example 4 (f) | Polymer 8 |

h) Measurement of the Ionic Conductivity of the Polymer Films Presented in Examples 4(a) to 4(f)

The ionic conductivity measurements of the symmetrical cells of Example 4(g) were carried out by alternating current electrochemical impedance spectroscopy recorded with a VPM3 multichannel potentiostat. The electrochemical impedance spectroscopy was performed between 200 mHz and 1 MHz in a temperature range of 20° C. to 80° C. (in increase and in decrease, each 5° C.).

Each electrochemical impedance measurement was obtained after the oven temperature was stabilized at the temperature (T).

The ionic conductivity of lithium ions was calculated from the electrochemical impedance spectroscopy measurements using Equation 1:

$$σ = \frac{1}{{R}_{t}} \times \frac{l}{A} \qquad Equation 1$$

wherein,
σ is the ionic conductivity (S·cm⁻¹), l is the thickness of the polymer film placed between the two stainless steel blocking electrodes, A is the contact area between the polymer and the two stainless steel electrodes, and Rₜ is the total resistance measured by electrochemical impedance spectroscopy.

The graphs in FIGS. 10 to 15 respectively present the ionic conductivity (S·cm⁻¹) results measured as a function of temperature (K⁻¹) for the symmetrical cells (Cells 1 to 6) assembled in Example 4(g).

FIG. 10 shows that an ionic conductivity value of 1.97×10⁻⁵ S·cm⁻¹ was obtained at a temperature of 50° C. for Cell 1 as described in Example 4(g).

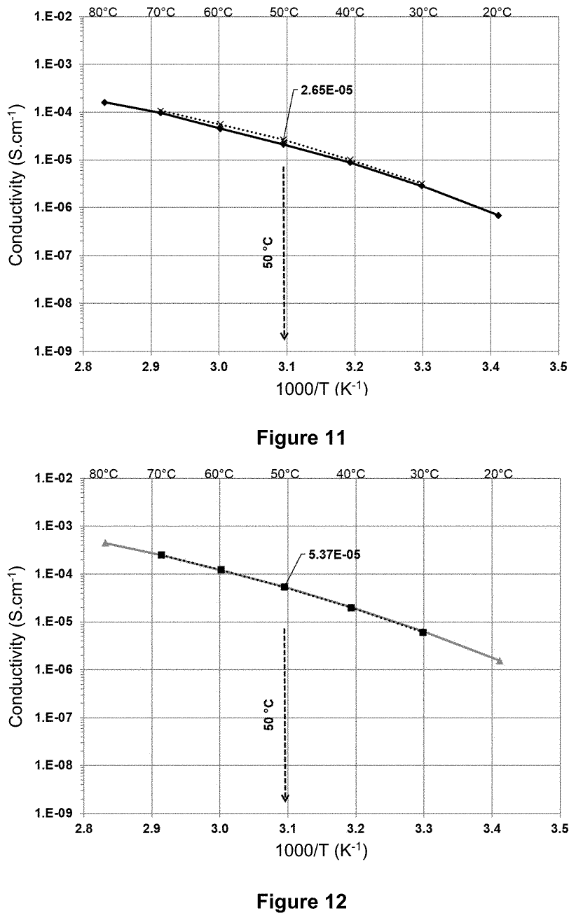

FIG. 11 shows that an ionic conductivity value of 2.65×10⁻⁵ S·cm⁻¹ was obtained at a temperature of 50° C. for Cell 2 as described in Example 4(g).

FIG. 12 shows that an ionic conductivity value of 5.37×10⁻⁵ S·cm⁻¹ was obtained at a temperature of 50° C. for Cell 3 as described in Example 4(g).

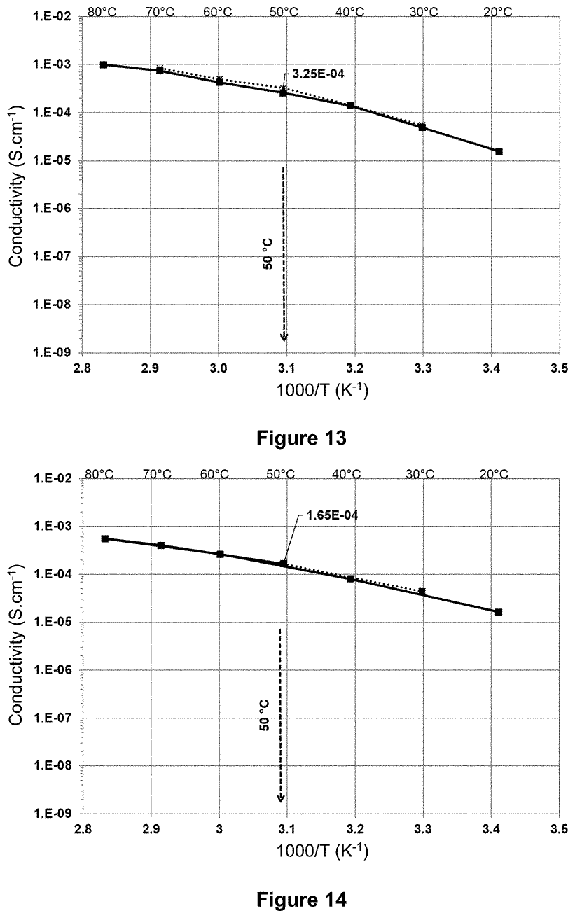

FIG. 13 shows that an ionic conductivity value of 3.25×10⁻⁴ S·cm⁻¹ was obtained at a temperature of 50° C. for Cell 4 as described in Example 4(g).

FIG. 14 shows that an ionic conductivity value of 1.65×10⁻⁴ S·cm⁻¹ was obtained at a temperature of 50° C. for Cell 5 as described in Example 4(g) (comparative).

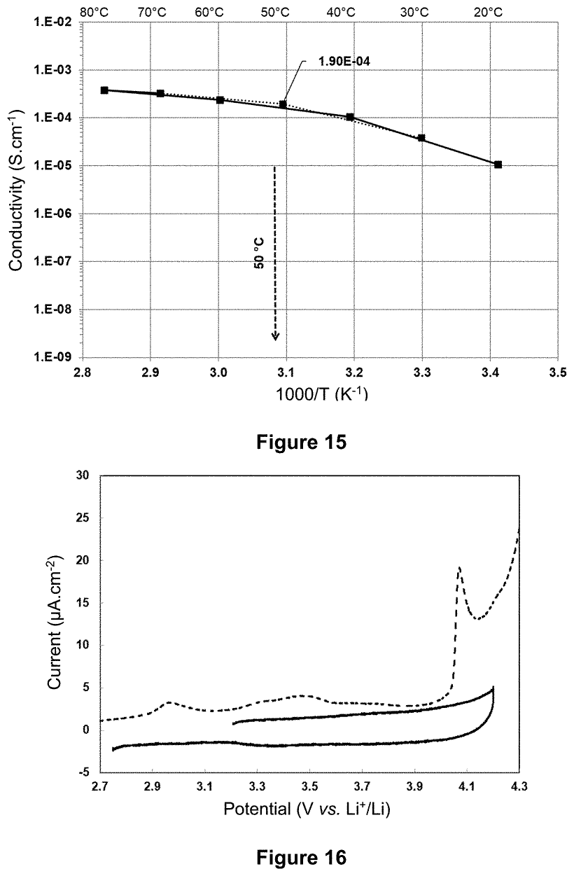

FIG. 15 shows that an ionic conductivity value of 1.90×10⁻⁴ S·cm⁻¹ was obtained at a temperature of 50° C. for Cell 6 as described in Example 4(g) (comparative).

### Example 5—Cyclic Voltammetry

### a) Preparation of Polymer Films for Cyclic Voltammetry Measurements

Cyclic voltammetry results were obtained for the polymers prepared in Examples 3(b) and 3(f) as well as for the polymers as described in the US′674 and US'174 patents and for a polyacrylonitrile (PAN) for comparative purposes.

The polymers prepared in Examples 3(b) and 3(f) and the comparative polymers were solubilized in a solvent mixture comprising water and methanol (80:20 by volume).

Once the polymers were dissolved, Ketjen™ black was added to the mixtures in a polymer:Ketjen™ black ratio (5:1 by weight).

The resulting blends were then mixed using a ball mill to adequately disperse and grind the Ketjen™ black agglomerates.

Viscosity of the mixtures thus obtained was adjusted with the solvent mixture comprising water and methanol (80:20 by volume).

The mixtures thus obtained were then applied to carbon-coated aluminum current collectors using a doctor-blade coating system with a hot plate. The polymer films thus obtained were dried at a temperature of 70° C. directly during coating.

The polymer films were then dried under vacuum in an oven at a temperature of 85° C. for 48 hours to remove residual solvent.

### b) Preparation of Symmetrical Cells for Cyclic Voltammetry Measurements

Preparation of symmetric cells comprising the polymer films prepared in Example 5(a) was performed entirely in an anhydrous chamber with a dew point of about −55° C. The symmetric cells were assembled in a button cell configuration with an active surface area of 2.01 cm². The symmetric cells were assembled according to the configurations indicated in Table 6.

TABLE 6
Symmetric cell configurations

| Symmetric cell | Polymer film | Polymer |
|---|---|---|
| Cell 7 (comparative cell) | Prepared in Example 5 (a) | As described in US′674 |
| Cell 8 (comparative cell) | Prepared in Example 5 (a) | As described in US′174 |
| Cell 9 | Prepared in Example 5 (a) | Prepared in Example 3 (b) |
| Cell 10 | Prepared in Example 5 (a) | Prepared in Example 3 (f) |
| Cell 11 (comparative cell) | Prepared in Example 5 (a) | Polyacrylonitrile (PAN) |

### c) Cyclic Voltammetry

The electrochemical stability in oxidation of the symmetric cells as described in Example 5(b) was measured using a VMP-3 type potentiostat.

FIG. 16 presents cyclic voltammetry results obtained for Cell 7 (comparative cell) (solid line) recorded at a scan rate of 0.067 mV/s between 2.7 V and 4.3 V vs. Li/Li⁺.

FIG. 16 also presents cyclic voltammetry results obtained for Cell 8 (comparative cell) (dashed line) recorded at a scan rate of 0.05 mV/s between 2.7 V and 4.3 V vs. Li/Li⁺.

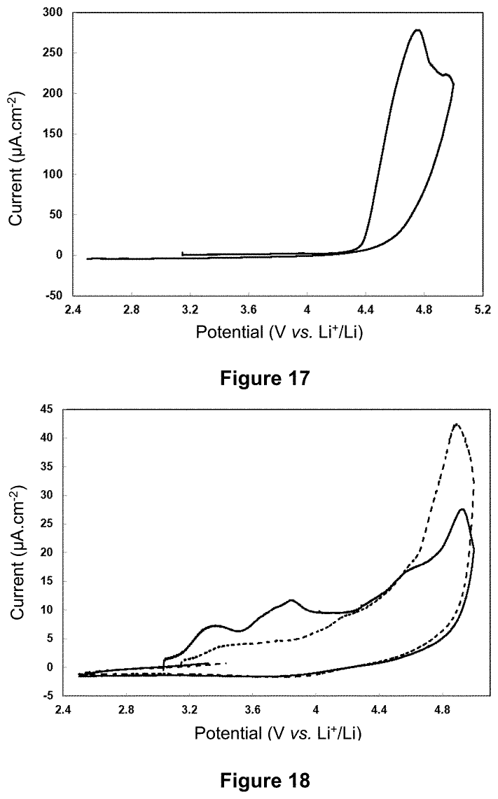

FIG. 17 presents cyclic voltammetry results obtained for Cell 7 (comparative cell) recorded at a scan rate of 0.067 mV/s between 2.5 V and 5 V vs. Li/Li⁺. FIG. 17 shows that oxidation of the polymer starts at a potential of about 4.37 V vs. Li/Li⁺.

FIG. 18 presents cyclic voltammetry results obtained for Cell 9 (solid line) and for Cell 10 (dashed line) recorded at a scan rate of 0.067 mV/s between 2.5 V and 5 V vs. Li/Li⁺.

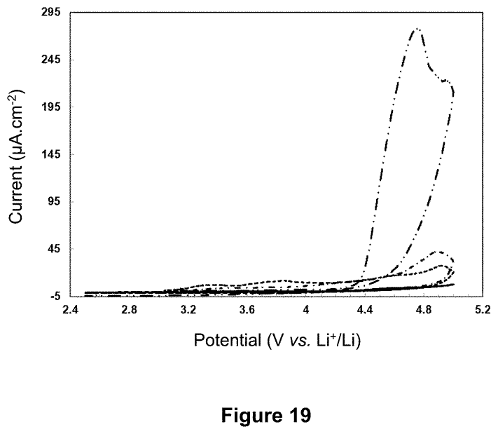

FIG. 19 presents cyclic voltammetry results obtained for Cell 7 (comparative cell) (line dot dash), for Cell 10 (line dot dash), for Cell 9 (dashed line) and for Cell 11 (comparative cell) (solid line) recorded at a scan rate of 0.067 mV/s between 2.5 V and 5 V vs. Li/Li⁺. FIG. 19 shows the results obtained during the first cycle.

Several modifications could be made to any of the above-described embodiments without departing from the scope of the present invention as contemplated. References, patents or scientific literature documents referred to in the present document are incorporated herein by reference in their entirety for all purposes.

What is claimed is:

1. An ionic polymer comprising at least one repeating unit comprising the reaction product between at least one compound of Formula 1 comprising at least two functional groups and a metal bis(halosulfonyl)imide of Formula 2: 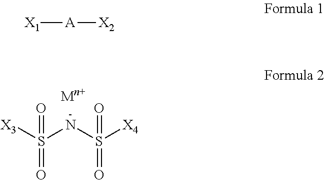
wherein,
A is a substituted or unsubstituted organic group selected from a linear or branched C₁-C₁₀alkylene, a linear or branched C₁-C₁₀alkyleneoxyC₁-C₁₀alkylene, a linear or branched poly(C₁-C₁₀alkyleneoxy)C₁-C₁₀alkylene, a linear or branched polyether and a linear or branched polyester;
X₁ and X₂ are functional groups independently and at each occurrence selected from a hydroxyl group, a thiol group and an amine group;
X₃ and X₄ are halogen atoms each independently selected from F, Cl, Br and I, X₃ and X₄ are both chlorine atoms; and
Mⁿ⁺ is an alkali or alkaline earth metal ion selected from the group consisting of Na⁺, K⁺, Li⁺, Ca²⁺ and Mg²⁺ ions, preferably Mⁿ⁺ is an alkali metal ion selected from the group consisting of Na⁺, K⁺ and Li⁺ ions, and more preferably Mⁿ⁺ is Li⁺.

2-5. (canceled)

6. The ionic polymer according to claim 1, wherein:
(i) X₁ and X₂ are both hydroxyl groups and the compound of Formula 1 is preferably selected from glycerol, alkane diols, 1,3-propanediol, 1,4-butanediol, 1,5-pentanediol, 1,6-hexanediol, 1,8-octanediol, 1,2-propanediol, 1,2-butanediol, 2,3-butanediol, 1,3-butanediol, 1,2-pentanediol, etohexadiol, p-menthane-3,8-diol, 2-methyl-2,4-pentanediol, polycaprolactone diol, ethylene glycol, diethylene glycol, triethylene glycol, tetraethylene glycol, pentaethylene glycol, polyethylene glycol, 2,2,3,3,4,4,5,5-octafluoro-1,6-hexanediol, and a combination of at least two thereof, preferably the compound of Formula 1 is a glycol or glycerol; or
(ii) the compound of Formula 1 is selected from alkane diamines, 1,3-propanediamine, 1,4-butanediamine, 1,5-pentanediamine, 1,6-hexanediamine, 1,8-octanediamine, 1,2-propanediamine, 1,2-butanediamine, 2,3-butanediamine, 1,3-butanediamine, 1,2-pentanediamine, 2,4-diamino-2-methylpentane, ethylenediamine, 1,8-diamino-3,6-dioxaoctane, 1,11-diamino-3,6,9-trioxaundecane, 4,9-dioxa-1,12-dodecanediamine, 1,14-diamino-3,6,9,12-tetraoxatetradecane, poly(ethylene glycol) diamine, D, ED or EDR series products commercialized under the brand JEFFAMINE®, and a combination of at least two thereof, preferably the compound of Formula 1 is a JEFFAMINE® D series product selected from JEFFAMINE® ED-600, ED-900 and ED-2003 or is a poly(ethylene glycol) diamine of formula H₂NCH₂CH₂(OCH₂CH₂)ₙNH₂, where n is 1 or 2.

7-11. (canceled)

12. The ionic polymer according to claim 1, wherein A is:
(i) an optionally substituted linear or branched C₁-C₁₀alkylene and the compound of Formula 1 is a compound of Formula 3: 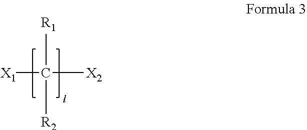
(ii) a linear or branched and optionally substituted poly(C₁-C₁₀alkyleneoxy)C₁-C₁₀alkylene and the compound of Formula 1 is a compound of Formula 4: 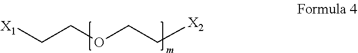
(iii) a linear or branched and optionally substituted polyether and the compound of Formula 1 is a compound of Formula 5: 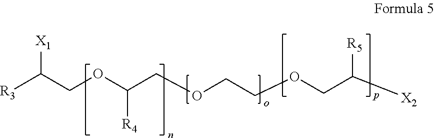
(iv) an optionally substituted aliphatic polyester, such as polycaprolactone, and the compound of Formula 1 is a compound of Formula 7: 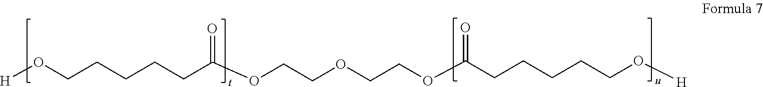
wherein,
X₁ and X₂ are as defined in claim 1;
R₁ and R₂ are independently and at each occurrence selected from a hydrogen atom, a hydroxyl group, a thiol group, an amine group, a halogen atom selected from F, Cl, Br and I, and linear or branched substituents selected from C₁-C₁₀alkyl, C₁-C₁₀alkyl-acrylate, C₁-C₁₀alkyl-methacrylate, oxycarbonyl-C₁-C₁₀alkyl-methacrylate, oxycarbonyl-C₁-C₁₀alkyl-acrylate, aminocarbonyl-C₁-C₁₀alkyl-methacrylate, aminocarbonyl-C₁-C₁₀alkyl-acrylate, oxycarbonylamino-C₁-C₁₀alkyl-methacrylate, and oxycarbonylamino-C₁-C₁₀alkyl-acrylate, preferably R₁ and R₂ are independently and at each occurrence selected from a hydrogen atom, a hydroxyl group, a thiol group, an amine group, a fluorine atom and a linear or branched substituent selected C₁-C₁₀alkyl, C₁-C₁₀alkyl-acrylate, C₁-C₁₀alkyl-methacrylate, oxycarbonylamino-C₁-C₁₀alkyl-methacrylate and oxycarbonylamino-C₁-C₁₀alkyl-acrylate;
R₃, R₄ and R₅ are independently and at each occurrence selected from C₁-C₁₀alkyl groups, preferably R₃, R₄ and R₅ are methyl groups;
l is a number in the range of 1 to 10;
m is a number in the range of 1 to 68, preferably m is a number in the range of 1 to 10;
n, o and p are selected such that the number average molecular weight of the polyether is between about 220 g/mol and about 2,000 g/mol, upper and lower limits included;
n and p are selected such that the sum (n+p) is comprised within the range of about 1 to about 6;
o is a number in the range of about 2 to about 39;
t and u are numbers in the range of 1 to 10; and
when the compound is of Formulae 3 or 4, X₁ and X₂ are preferably both hydroxyl groups; and
when the compound is of Formula 5, X₁ and X₂ are preferably both amine groups.

13-21. (canceled)

22. The ionic polymer according to claim 1, the ionic polymer comprising at least one repeating unit of Formula 8 (a) or is a polymer of Formula 8 (b): 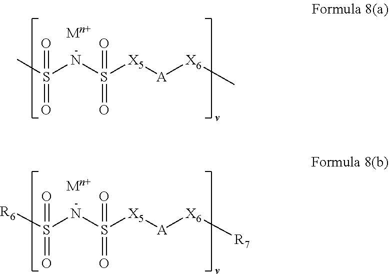
wherein,
A is a substituted or unsubstituted organic group independently and at each occurrence selected from a linear or branched C₁-C₁₀alkylene, a linear or branched C₁-C₁₀alkyleneoxyC₁-C₁₀alkylene, a linear or branched poly(C₁-C₁₀alkyleneoxy)C₁-C₁₀alkylene, a linear or branched polyether and a linear or branched polyester;
X₅ and X₆ are each independently selected from an oxygen atom, a sulfur atom and an —NH group, preferably X₅ and X₆ are both oxygen atoms, both sulfur atoms, or both NH groups;
R₆ is selected from a hydroxyl group, a thiol group, an amine group and a R₇—X₅-A-X₆— group;
R₇ is a crosslinkable group independently at each occurrence selected from acrylate, methacrylate, C₁-C₁₀alkyl-acrylate, C₁-C₁₀alkyl-methacrylate, carbonyl-C₁-C₁₀alkyl-methacrylate carbonyl-C₁-C₁₀alkyl-acrylate, carbonyloxy-C₁-C₁₀alkyl-methacrylate, carbonyloxy-C₁-C₁₀alkyl-acrylate, carbonylamino-C₁-C₁₀alkyl-methacrylate and carbonylamino-C₁-C₁₀alkyl-acrylate;
Mⁿ⁺ is an alkali or alkaline earth metal ion selected from the group consisting of Na⁺, K⁺, Li⁺, Ca²⁺ and Mg²⁺ ions, preferably Mⁿ⁺ is an alkali metal ion selected from the group consisting of Na⁺, K⁺ and Li⁺ ions, and more preferably Mⁿ⁺ is Li⁺; and
v is a number selected such that the number average molecular weight of the ionic polymer is between about 8,000 g/mol and about 150,000 g/mol, and preferably between about 8,000 g/mol and about 60,000 g/mol, upper and lower limits included.

23-28. (canceled)

29. The ionic polymer according to claim 1, the ionic polymer comprising at least one repeating unit selected from the repeating unit of Formulae 9 to 12: 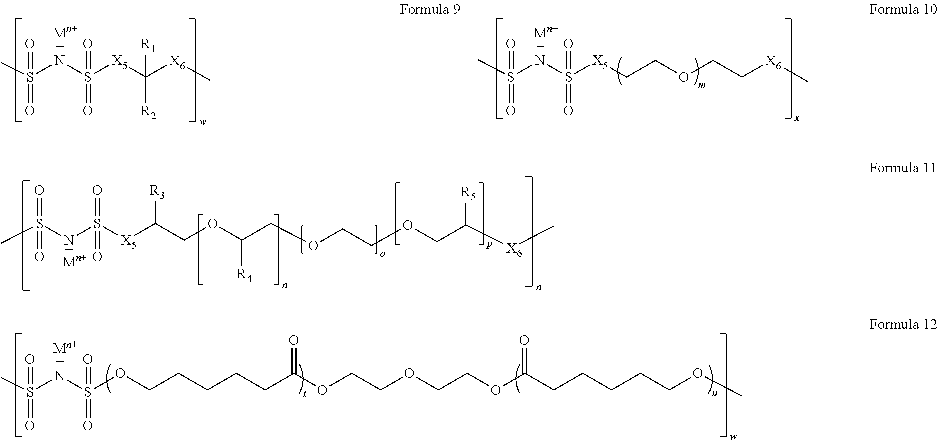
wherein,
Mⁿ⁺ is an alkali or alkaline earth metal ion selected from the group consisting of Na⁺, K⁺, Li⁺, Ca²⁺ and Mg²⁺ ions, preferably Mⁿ⁺ is an alkali metal ion selected from the group consisting of Na⁺, K⁺ and Li⁺ ions, more preferably Mⁿ⁺ is Li⁺;
X₅ and X₆ are each independently selected from an oxygen atom, a sulfur atom and an NH group, preferably X₅ and X₆ are both oxygen atoms, both sulfur atoms, or both NH groups;
R₁ and R₂ are independently and at each occurrence selected from a hydrogen atom, a hydroxyl group, a thiol group, an amine group, a halogen atom selected from F, Cl, Br and I, and linear or branched substituents selected from C₁-C₁₀alkyl, C₁-C₁₀alkyl-acrylate, C₁-C₁₀alkyl-methacrylate, oxycarbonyl-C₁-C₁₀alkyl-methacrylate, oxycarbonyl-C₁-C₁₀alkyl-acrylate, aminocarbonyl-C₁-C₁₀alkyl-methacrylate, aminocarbonyl-C₁-C₁₀alkyl-acrylate, oxycarbonylamino-C₁-C₁₀alkyl-methacrylate, and oxycarbonylamino-C₁-C₁₀alkyl-acrylate, preferably R₁ and R₂ are independently and at each occurrence selected from a hydrogen atom, a hydroxyl group, a thiol group, an amine group, a fluorine atom and a linear or branched substituent selected from C₁-C₁₀alkyl-acrylate, C₁-C₁₀alkyl-methacrylate, oxycarbonylamino-C₁-C₁₀alkyl-methacrylate and oxycarbonylamino-C₁-C₁₀alkyl-acrylate;
R₃, R₄ and R₅ are independently and at each occurrence selected from C₁-C₁₀alkyl groups, preferably R₃, R₄ and R₅ are methyl groups;
l, t and u are numbers in the range of 1 to 10;
m is a number in the range of 1 to 68;
n and p are selected such that the sum (n+p) is in the range of about 1 to about 6;
o is a number in the range of about 2 to about 39; and
w, x, y and z are numbers selected such that the number average molecular weight of the ionic polymer is between about 8,000 g/mol and about 150,000 g/mol, and preferably between about 8 000 g/mol and about 60 000 g/mol, upper and lower limits included.

30-55. (canceled)

56. The ionic polymer according to claim 1, the ionic polymer comprising at least one fragment selected from the fragments of Formulae 13 to 28: 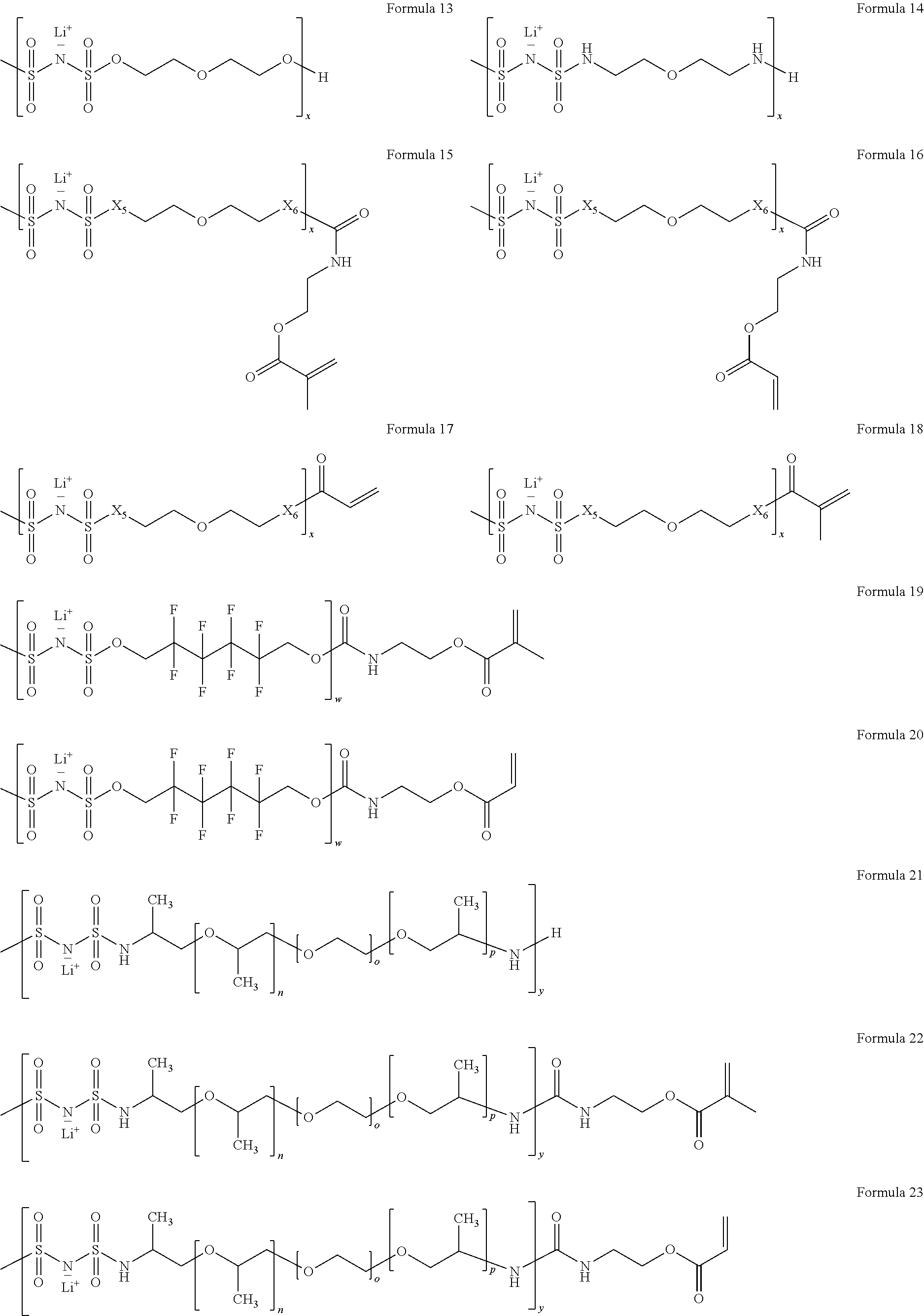 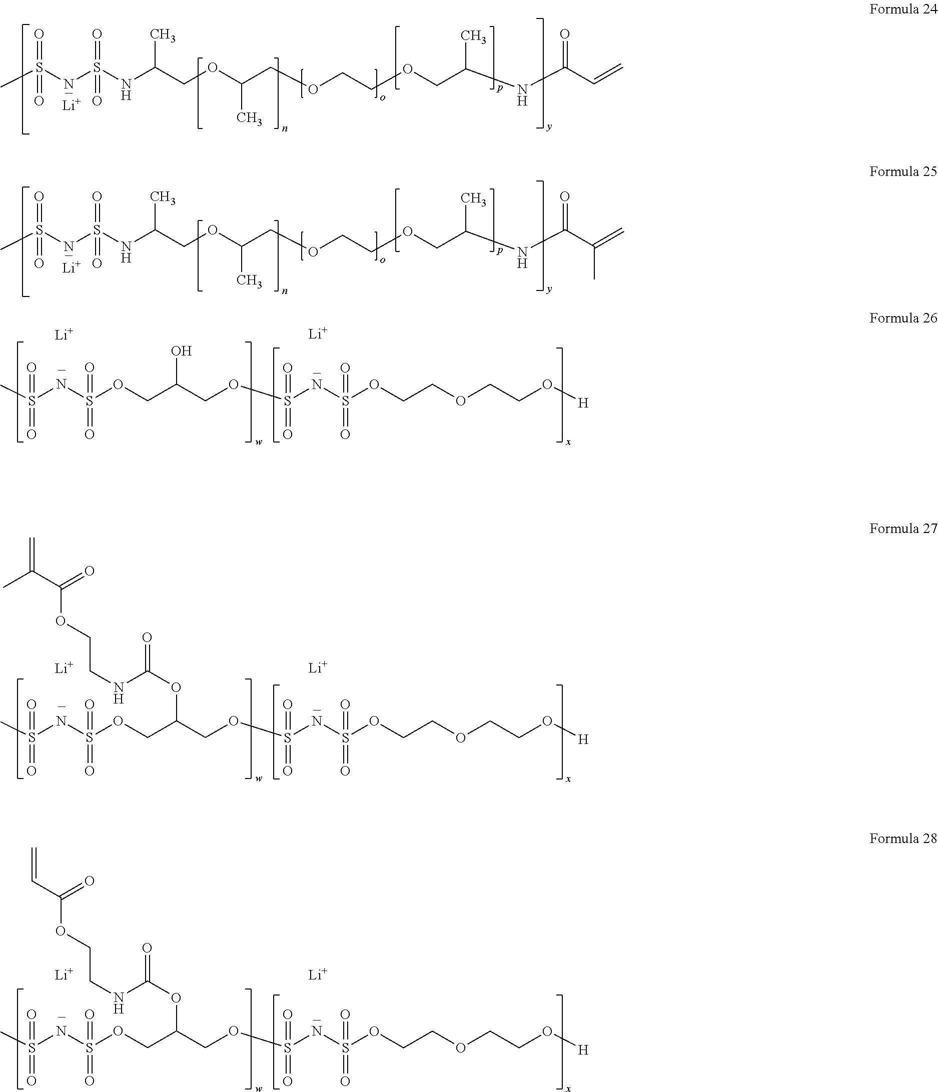
wherein,
X₅ and X₆ are each independently selected from an oxygen atom, a sulfur atom and an NH group, preferably X₅ and X₆ are both oxygen atoms, both sulfur atoms, or both NH groups;
n and p are selected such that the sum (n+p) is in the range of about 1 to about 6;
o is a number in the range of about 2 to about 39; and
w, x and y are numbers selected such that the number average molecular weight of the ionic polymer is between about 8,000 g/mol and about 150,000 g/mol, and preferably between about 8,000 g/mol and about 60,000 g/mol, upper and lower limits included.

57-99. (canceled)

100. A polymer composition comprising at least one ionic polymer as defined in claim 1 and optionally at least one additional component or additive preferably selected from ionic conductors, inorganic particles, glass particles, ceramic particles, and a combination of at least two thereof, more preferably the additional component or additive is a filler additive preferably selected from titanium dioxide (TiO₂), alumina (Al₂O₃) and silicon dioxide (SiO₂) particles or nanoparticles.

101-104. (canceled)

105. The polymer composition according to claim 100, wherein said polymer composition is a solid polymer electrolyte composition, or wherein said polymer composition is a binder for electrode material, or wherein said polymer composition is used in an electrochemical cell, or wherein said polymer composition is used in an electrochromic material, or wherein said polymer composition is used in a supercapacitor, preferably a carbon-carbon supercapacitor.

106-110. (canceled)

111. A solid polymer electrolyte composition comprising:
an ionic polymer as defined in claim 1;
optionally at least one salt, preferably an ionic salt selected from a lithium salt, a sodium salt, a potassium salt, a calcium salt, and a magnesium salt, more preferably the ionic salt is a lithium salt preferably selected from lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyanoimidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCl), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiTf), lithium fluoroalkylphosphate Li[PF₃(CF₂CF₃)₃] (LiFAP), lithium tetrakis(trifluoroacetoxy)borate Li[B(OCOCF₃)₄] (LiTFAB), lithium bis(1,2-benzenediolato(2-)-O,O′)borate Li[B(C₆O₂)₂] (LiBBB), and a combination of at least two thereof; and
optionally at least one additional component or additive preferably selected from ionically conductive materials, inorganic particles, glass particles, ceramic particles, and a combination of at least two thereof.

112-118. (canceled)

119. A solid polymer electrolyte comprising an ionic polymer as defined in claim 1, wherein said ionic polymer is optionally crosslinked.

120. An electrode material comprising:
an electrochemically active material preferably selected from a metal oxide, a lithium metal oxide, a metal phosphate, a lithiated metal phosphate, a titanate, and a lithium titanate, wherein the metal of the electrochemically active material is preferably selected from titanium (Ti), iron (Fe), magnesium (Mg), manganese (Mn), vanadium (V), nickel (Ni), cobalt (Co), aluminum (Al), and a combination of at least two thereof, the electrochemically active material preferably being in the form of particles;
an ionic polymer as defined in claim 1, wherein the polymer is preferably a binder;
optionally at least one electronically conductive material preferably selected from carbon black, acetylene black, graphite, graphene, carbon fibers, carbon nanofibers, carbon nanotubes, and a combination of at least two thereof, and preferably the electronically conductive material is acetylene black;
optionally at least one additional component or additive preferably selected from ionic conductors, inorganic particles, glass or ceramic particles, nanoceramics, and salts, preferably the additional component or additive is selected from Al₂O₃, TiO₂ and SiO₂;
wherein said electrode material is a positive electrode material or a negative electrode material, preferably wherein said electrode material is a negative electrode material and the electrochemically active material is a lithium titanate, and more preferably the lithium titanate is a carbon-coated lithium titanate.

121-134. (canceled)

135. An electrode comprising an electrode material as defined in claim 120 on a current collector.

136. An electrochemical cell comprising a negative electrode, a positive electrode, and an electrolyte, wherein at least one of the negative electrode, the positive electrode, and the electrolyte comprises an ionic polymer as defined in claim 1.

137. An electrochemical cell comprising a negative electrode, a positive electrode, and an electrolyte, wherein at least one of the negative electrode and the positive electrode is as defined in claim 135.

138. An electrochemical cell comprising a negative electrode, a positive electrode and a solid polymer electrolyte as defined in claim 119.

139. An electrochemical accumulator comprising at least one electrochemical cell as defined in claim 136, wherein said electrochemical accumulator is preferably a battery selected from a lithium battery, a lithium-ion battery, a sodium battery, a sodium-ion battery, a magnesium battery, and a magnesium-ion battery, and preferably said battery is a lithium or a lithium-ion battery.

140-141. (canceled)

142. A process for preparing an ionic polymer as defined in claim 1, the process comprising the following steps:
(i) preparing a metal bis(halosulfonyl)imide of Formula 2; and
(ii) reacting at least one compound of Formula 1 with said metal bis(halosulfonyl)imide of Formula 2, optionally carried out in the presence of a solvent preferably selected from N,N-dimethylformamide, N-methyl-2-pyrrolidone, dimethylacetamide, carbon tetrachloride, chloroform, acetonitrile, tetrahydrofuran, and a miscible combination of at least two thereof, and more preferably the solvent is N,N-dimethylformamide.

143. The process according to claim 142, said process further comprising at least one of the following steps:
a step of preparing a bis(halosulfonyl)imide preferably carried out by the reaction between sulfamic acid and a halosulfonic acid in the presence of at least one halogenating agent, wherein the halogenating agent is preferably selected from phosphorus trichloride, phosphorus pentachloride, thionyl chloride, thionyl fluoride, phosphorus oxychloride and oxalyl chloride, preferably wherein the bis(halosulfonyl)imide is a bis(chlorosulfonyl)imide, preferably wherein the step of preparing a bis(halosulfonyl)imide is carried out at a temperature in the range of from about 60° C. to about 150° C., or from about 70° C. to about 145° C., or from about 80° C. to about 140° C., or from about 90° C. to about 100° C., or from about 110° C. to about 140° C., or from about 120° C. to about 140° C., or from about 125° C. to about 140° C., or from about 125° C. to about 135° C., upper and lower limits included, and preferably wherein the step of preparing a bis(halosulfonyl)imide is carried out at a temperature of about 130° C. for a period of about 24 hours;
a post-functionalization or a post-polymerization modification step preferably carried out to introduce at least one crosslinkable functional group, and preferably carried out by the reaction between at least one functional group and at least one precursor of a crosslinkable functional group preferably selected from acrylate, methacrylate, C₁-C₁₀alkyl-acrylate, C₁-C₁₀alkyl-methacrylate, oxycarbonyl-C₁-C₁₀alkyl-methacrylate, oxycarbonyl-C₁-C₁₀alkyl-acrylate, aminocarbonyl-C₁-C₁₀alkyl-methacrylate aminocarbonyl-C₁-C₁₀alkyl-acrylate, oxycarbonylamino-C₁-C₁₀alkyl-methacrylate, oxycarbonylamino-C₁-C₁₀alkyl-acrylate, carbonyloxy-C₁-C₁₀alkyl-methacrylate, carbonyloxy-C₁-C₁₀alkyl-acrylate, carbonylamino-C₁-C₁₀alkyl-methacrylate, and carbonylamino-C₁-C₁₀alkyl-acrylate;
a separation or purification step preferably carried out by a liquid chromatography method or a filtration method, preferably the liquid chromatography method is steric exclusion chromatography and the filtration method is a membrane filtration method;
a step of coating the polymer composition preferably performed by at least one method selected from a doctor blade coating method, a comma coating method, a reverse-comma coating method, a printing method, a gravure coating method, and a slot-die coating method, and more preferably performed by at least one method selected from a doctor blade coating method and a slot-die coating method;
a step of drying the polymer composition to remove any residual solvent and/or water;
a crosslinking step preferably carried out by UV irradiation, by heat treatment, by microwave irradiation, under an electron beam, by gamma irradiation, or by X-ray irradiation, more preferably carried out by UV irradiation, heat treatment, or under an electron beam, wherein the crosslinking step is preferably carried out in the presence of at least one of a crosslinking agent, a thermal initiator, a photoinitiator, a catalyst, a plasticizing agent, or a combination of at least two thereof, preferably the crosslinking agent is 2,2-dimethoxy-2-phenylacetophenone (Irgacure™ 651);
wherein, if present, the step of drying the polymer composition and the step of coating the polymer composition are preferably performed simultaneously.

144-150. (canceled)

151. The process according to claim 142, wherein the step of preparing a metal bis(halosulfonyl)imide is:
carried out by a metalation reaction between a bis(halosulfonyl)imide and at least one metalating agent, optionally in the presence of a solvent, the metalating agent preferably comprises an alkali metal selected from lithium, sodium, potassium, calcium, and magnesium, preferably wherein the metalating agent is a lithiating agent preferably selected from lithium hydroxide, lithium carbonate, lithium hydrogen carbonate, lithium hydride, lithium chloride, lithium bromide, lithium iodide, a lithium carboxylate of formula RCO₂Li (wherein R is a linear or branched C₁-C₁₀alkyl group or an aromatic hydrocarbon), lithium oxalate, and metallic lithium, and more preferably the lithiating agent is lithium chloride (LiCl);
carried out at a temperature in the range of from about 20° C. to about 150° C., or from about 30° C. to about 135° C., or from about 40° C. to about 130° C., or from about 50° C. to about 125° C., or from about 60° C. to about 120° C., or from about 70° C. to about 115° C., or from about 80° C. to about 110° C., or from about 90° C. to about 105° C., upper and lower limits included; and
carried out a time period in the range of from about 10 hours to about 48 hours, or from about 10 hours to about 24 hours, or from about 12 hours to about 24 hours, upper and lower limits included.

152-162. (canceled)

163. The process according to claim 142, wherein the step of reacting at least one compound of Formula 1 with said metal bis(halosulfonyl)imide of Formula 2 is a polymerization step preferably carried out by polycondensation or polyesterification.

164-170. (canceled)

171. The process according to claim 163, wherein the polymerization step is carried out in the presence of at least one base and optionally of at least one polymerization catalyst and/or at least one co-catalyst and/or optionally at least one acylation catalyst, wherein the polymerization catalyst is preferably selected from the group consisting of an acidic catalyst, a nucleophilic catalyst, and a boron-based catalyst, and more preferably wherein:
the acidic catalyst is a Lewis acid catalyst;
the nucleophilic catalyst is selected from the group consisting of 4-dimethylaminopyridine, pyridine, and other pyridine derivatives, and preferably the nucleophilic catalyst is 4-dimethylaminopyridine;
the boron-based catalyst is a boric acid-based catalyst, a boronic acid-based catalyst, or a borinic acid-based catalyst; and
the polymerization catalyst is selected from diarylboronic acids of formula Ar₂BOH (wherein Ar is an aryl group), diphenylboronic acid, trifluorophenyl boronic acid, 9H-9-bora-10-thiaanthracene-9-ol, 10H-phenoxaborin-10-ol, boron tribromide, boron trichloride, acyl fluoroborates, triethyloxonium fluoroborate, boron trifluoride etherate, boron trifluoride, tris(pentafluorophenyl)borane, and a combination of at least two thereof when compatible.

172-200. (canceled)

201. A solid polymer electrolyte composition comprising:
a polymer composition as defined in claim 100;
optionally at least one salt, preferably an ionic salt selected from a lithium salt, a sodium salt, a potassium salt, a calcium salt, and a magnesium salt, more preferably the ionic salt is a lithium salt preferably selected from lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyanoimidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCl), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiTf), lithium fluoroalkylphosphate Li[PF₃(CF₂CF₃)₃] (LiFAP), lithium tetrakis(trifluoroacetoxy)borate Li[B(OCOCF₃)₄] (LiTFAB), lithium bis(1,2-benzenediolato(2-)-O,O′)borate Li[B(C₆O₂)₂] (LiBBB), and a combination of at least two thereof; and
optionally at least one additional component or additive preferably selected from ionically conductive materials, inorganic particles, glass particles, ceramic particles, and a combination of at least two thereof.

202. A solid polymer electrolyte comprising a solid polymer electrolyte composition as defined in claim 111, wherein said ionic polymer is optionally crosslinked.

203. A solid polymer electrolyte comprising a solid polymer electrolyte composition as defined in claim 201, wherein said ionic polymer is optionally crosslinked.

204. An electrode material comprising:
an electrochemically active material preferably selected from a metal oxide, a lithium metal oxide, a metal phosphate, a lithiated metal phosphate, a titanate, and a lithium titanate, wherein the metal of the electrochemically active material is preferably selected from titanium (Ti), iron (Fe), magnesium (Mg), manganese (Mn), vanadium (V), nickel (Ni), cobalt (Co), aluminum (Al), and a combination of at least two thereof, the electrochemically active material preferably being in the form of particles;
a polymer composition as defined in claim 100, wherein the polymer composition is preferably a binder;
optionally at least one electronically conductive material preferably selected from carbon black, acetylene black, graphite, graphene, carbon fibers, carbon nanofibers, carbon nanotubes, and a combination of at least two thereof, and preferably the electronically conductive material is acetylene black;
optionally at least one additional component or additive preferably selected from ionic conductors, inorganic particles, glass or ceramic particles, nanoceramics, and salts, preferably the additional component or additive is selected from Al₂O₃, TiO₂ and SiO₂;
wherein said electrode material is a positive electrode material or a negative electrode material, preferably wherein said electrode material is a negative electrode material and the electrochemically active material is a lithium titanate, and more preferably the lithium titanate is a carbon-coated lithium titanate.

205. An electrode comprising an electrode material as defined in claim 204 on a current collector.

206. An electrochemical cell comprising a negative electrode, a positive electrode, and an electrolyte, wherein at least one of the negative electrode, the positive electrode, and the electrolyte comprises a polymer composition as defined in claim 100.

207. An electrochemical cell comprising a negative electrode, a positive electrode, and an electrolyte, wherein at least one of the negative electrode and the positive electrode is as defined in claim 204.

208. An electrochemical cell comprising a negative electrode, a positive electrode and a solid polymer electrolyte as defined in claim 202.

209. An electrochemical cell comprising a negative electrode, a positive electrode and a solid polymer electrolyte as defined in claim 203.

210. An electrochemical accumulator comprising at least one electrochemical cell as defined in claim 137, wherein said electrochemical accumulator is preferably a battery selected from a lithium battery, a lithium-ion battery, a sodium battery, a sodium-ion battery, a magnesium battery, and a magnesium-ion battery, and preferably said battery is a lithium or a lithium-ion battery.

211. An electrochemical accumulator comprising at least one electrochemical cell as defined in claim 138, wherein said electrochemical accumulator is preferably a battery selected from a lithium battery, a lithium-ion battery, a sodium battery, a sodium-ion battery, a magnesium battery, and a magnesium-ion battery, and preferably said battery is a lithium or a lithium-ion battery.

212. An electrochemical accumulator comprising at least one electrochemical cell as defined in claim 206, wherein said electrochemical accumulator is preferably a battery selected from a lithium battery, a lithium-ion battery, a sodium battery, a sodium-ion battery, a magnesium battery, and a magnesium-ion battery, and preferably said battery is a lithium or a lithium-ion battery.

213. An electrochemical accumulator comprising at least one electrochemical cell as defined in claim 207, wherein said electrochemical accumulator is preferably a battery selected from a lithium battery, a lithium-ion battery, a sodium battery, a sodium-ion battery, a magnesium battery, and a magnesium-ion battery, and preferably said battery is a lithium or a lithium-ion battery.

214. An electrochemical accumulator comprising at least one electrochemical cell as defined in claim 208, wherein said electrochemical accumulator is preferably a battery selected from a lithium battery, a lithium-ion battery, a sodium battery, a sodium-ion battery, a magnesium battery, and a magnesium-ion battery, and preferably said battery is a lithium or a lithium-ion battery.

215. An electrochemical accumulator comprising at least one electrochemical cell as defined in claim 209, wherein said electrochemical accumulator is preferably a battery selected from a lithium battery, a lithium-ion battery, a sodium battery, a sodium-ion battery, a magnesium battery, and a magnesium-ion battery, and preferably said battery is a lithium or a lithium-ion battery.

216. A process for preparing a polymer composition as defined in claim 100, the process comprising the following steps:
(i) preparing a metal bis(halosulfonyl)imide of Formula 2; and
(ii) reacting at least one compound of Formula 1 with said metal bis(halosulfonyl)imide of Formula 2, optionally carried out in the presence of a solvent preferably selected from N,N-dimethylformamide, N-methyl-2-pyrrolidone, dimethylacetamide, carbon tetrachloride, chloroform, acetonitrile, tetrahydrofuran, and a miscible combination of at least two thereof, and more preferably the solvent is N,N-dimethylformamide.
